(19) United States
(12) Patent Application Publication
(10) Pub. No.: US 2014/0339098 A1
(43) Pub. Date: Nov. 20, 2014

(54) PROCESS AND CATALYST FOR THE ELECTROCHEMICAL REDUCTION OF CARBON DIOXIDE

(71) Applicant: SOLVAY SA, Brussels (BE)

(72) Inventors: Adam Wieslaw Mazur, Mason, OH (US); Jean-Yves Nedelec, L'hay Les Roses (FR); Christine Cachet-Vivier, Maisons-alfort (FR); Maniyan Padmanilayam, Mason, OH (US); Armin T. Liebens, Brussels (BE)

(21) Appl. No.: 14/364,379

(22) PCT Filed: Dec. 13, 2012
(86) PCT No.: PCT/EP2012/075452

§ 371 Date: Jun. 11, 2014

Related U.S. Application Data
(60) Provisional application No. 61/576,121, filed on Dec. 15, 2011.

(51) Int. Cl. C25B 11/04; C07F 9/48; C07F 9/6512; C25B 1/00; C07F 9/6561; C07F 9/6509; C07F 9/6503; C07F 9/58; C07F 9/6539

(52) U.S. Cl. CPC C25B 11/04; C07F 9/581; C07F 9/485; C07F 9/65121; C07F 9/6539; C07F 9/6561; C07F 9/650958; C07F 9/65032; C25B 1/00
USPC 205/555; 546/22; 558/156; 544/243; 548/119; 546/23; 544/337

(57) ABSTRACT

A process for the catalyzed electrochemical reduction of carbon dioxide wherein a metal organic framework comprising metal ions and an organic ligand is used as a catalyst and novel metal organic frameworks based on bisphosphonic acids.

### CROSS REFERENCE TO A RELATED APPLICATION

This application claims priority to U.S. provisional application No. 61/576,121 filed on Dec. 15, 2011, the whole content of this application being incorporated herein by reference for all purposes.

Energy generation via fossil fuels in most cases is associated with the generation of significant amounts of carbon dioxide, a gas playing a central role in the greenhouse effect.

Accordingly, one of the challenges in the near future will be reduction of carbon dioxide release to the Earth atmosphere.

While storage in underground cavities may be considered a short term solution to reduce the level of carbon dioxide in the atmosphere, it is no sustainable solution for the dealing with large amounts of carbon dioxide.

The biological conversion of carbon dioxide through photosynthesis is also well known. However, only a very small amount of the absorbed energy in this process becomes available in a technologically usable form as the majority of the solar energy needed is utilized for the lifecycle process of the respective organisms. As a consequence, this, at least for the time being, does not appear to be a commercially viable process for the conversion of solar energy into storable energy, which will be one of the major challenges in future.

Direct reduction of carbon dioxide to fuels in a hydrogen atmosphere requires high amounts of energy to overcome high activation energy levels.

Electrochemical reduction of carbon dioxide has been observed in a number of systems. In particular the reduction of carbon dioxide to a mixture of hydrogen and carbon monoxide (known as syngas) appears to be interesting in this regard. Syngas can be converted in commercially feasible processes into a number of fuels, which at the end would open the way to energy production on a large scale independent of fossil fuels.

The standard carbon dioxide potentials to stable products would at a first glance appear to indicate thermodynamic feasibility under mild thermodynamic conditions; the experimental potentials, however, are much more negative due to a large energy need.

The high activation energy required to convert the linear, stable carbon dioxide molecule into a trigonal anion radical intermediate formed as a result of the transfer of one electron to the carbon dioxide molecule is one of the obstacles to be overcome. In order to make carbon dioxide conversion energetically beneficial, suitable ways to reduce this activation energy have to be found.

Catalysts lower activation energy of chemical reactions. In addition, catalysis may also help to direct the processes to the desired end-products as catalysis can influence both electronic and geometrical properties of the species involved in the process.

The electrocatalytic conversion of carbon dioxide to carbon monoxide using transition metal catalysts is described in U.S. Pat. No. 4,668,349 wherein a transition metal complex with square planar geometry is used. The energy consumption of the process is not fully satisfactory.

U.S. Pat. No. 5,068,057 discloses a method for the conversion of carbon dioxide to a carbon monoxide rich gas mixture. Carbon dioxide is contacted with a catalyst essentially consisting of Pd or Pt at a temperature of from 650 to 1000° C., which makes the process unsuitable for energy storage purposes due to the high energy consumption.

U.S. Pat. No. 5,284,563 discloses a process for the reduction of carbon dioxide with a modified Ni(cyclam) catalyst.

The catalyst systems for the reduction of carbon dioxide in general use metals as essential catalyst element, which limits the possibility of structural engineering of the catalyst to adopt the catalyst system to the needs of a specific reaction system.

As of today, no commercially viable process for the electrochemical reduction of carbon dioxide into desired products where the catalyst system can be easily structurally engineered to the specific conditions exists.

Metal organic frameworks (MOF) are compounds comprising metal ions or atom clusters coordinated to organic molecules to form one-, two- or three-dimensional structures, which are often porous.

The organic molecules, usually referred to as linker, have significant effects on structure and properties of a MOF.

MOF may be formed by the self-assembly of simple components on a nanodimensional scale. In contrast to classic organic polymers, the monomers in a MOF are not connected by covalent bonds but predominantly by ionic bonds. This requires organic molecules having a certain degree of polarity which may form such ionic bonds with inorganic metal salts in suitable solvent systems, preferably in aqueous systems.

The initial studies on MOF systems were developed from the study of zeolites and still today similar synthetic routes are used for the manufacture of MOF.

MOFs have been developed for a number of applications like hydrogen storage, gas purification, gas separation and heterogeneous catalysis.

MOF are made in a variety of forms differing in pore size and shape, depending on the intended use.

Use of MOF for catalytic purposes is based on the advantage that the ordered structure of an MOF offers the opportunity to spatially separate different catalytic centres at nanoscale dimensions.

A limiting factor for the broad application of MOF in catalytic reactions is the chemical and thermal stability of those systems. Most MOF are based on benzoic acids having two or three carboxylic groups due to the good commercial availability of the respective starting materials.

A catalyst suitable for the electrochemical reduction of carbon dioxide would have to provide a proper structural matrix, suitable binding sites for concentrating the carbon dioxide in the catalytic space and facilitating its conformational change from the linear to the trigonal geometry referred to above and finally to facilitate the electron transfer to the carbon dioxide molecule.

Despite the increasing interest in MOF for catalytic purposes the electrochemistry of MOF has only been investigated to a limited extent, e.g. in Yang et al., Solid State Sci. 11(3), 643-650 (2009), Wang et al, Solid State Sci. 11(1), 61-67, 2009 and Bai et al., Journal of Cluster Sci. 19(4), 561-572 (2008).

Although the electrocatalytical reduction of carbon dioxide has been the subject of intense investigation, there is no commercially viable technology available yet. The key limitation up to now has been the limited number of viable electrocatalysts for CO₂ reduction. The best catalysts known today are metals, in particular silver, which, however, has a limited economic feasibility.

Accordingly, there still exists a need for electrocatalysts for the electrochemical reduction of carbon dioxide which can be tailored by molecular and engineering operations to provide energetically viable electrolytic conditions for making fuels from carbon dioxide.

It was accordingly an object of the present invention to provide a process for the electrochemical reduction of carbon dioxide overcoming the disadvantages of the known systems as described above.

It was a further object of the invention to provide suitable catalytic materials for the electrochemical reduction of carbon dioxide in an economically feasible and energy beneficial manner.

These objects are achieved through the process in accordance with the present invention as defined in claim 1 and by metal organic frameworks as defined in independent claim 7.

Preferred embodiments of the present invention are set forth in the dependent claims and the detailed description hereinafter.

According to a first aspect of the invention, a process for the catalyzed electrochemical reduction of carbon dioxide is provided wherein a metal organic framework comprising metal ions and an organic ligand is used as a catalyst.

In principle, any metal organic framework (MOF) comprising metal ions and organic ligands may be used in the process in accordance with the invention. As herein used, the term “metal” should be understood in its broadest meaning; it includes alkaline-earth metals (i.e. metals of group 2), transition metals (i.e. metals of groups 3 to 12), post-transition metals of groups 13 to 15 (e.g. Al, Ga, In, TI, Sn, Pb and Bi), and even metalloids of groups 14 and 15 (i.e. Si, Ge, As and Sb). Then, while there is no specific limitation as to the nature of the metal in the MOF, i.e. in principle any metal of groups 2 to 15 of the periodic system (i.e. Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, TI, Si, Ge, Sn, Pb, As, Sb and Bi) may be used, it has proved advantageous under certain circumstances to use MOF with metal ions derived from copper, iron and nickel, in particular copper and nickel, and particularly preferred copper, in the process in accordance with the present invention.

The nature of the anion in the metal compound used as starting material for the synthesis of MOF's is not particularly critical and inorganic as well as organic anions are suitable. Suitable inorganic anions are hydroxide, sulfate, nitrate, nitrite, sulphite, bisulfite, phosphate, hydrogen phosphate, dihydrogen phosphate, triphosphate, phosphite, chloride, chlorate, bromate, iodide, carbonate and bicarbonate, of which hydroxides and nitrates due to their easy availability have proved to be advantageous in certain cases. Organic anions can also be broadly selected from common counteranions for metals and just as an example, formate, acetate and propionate may be mentioned here, of which acetate is generally most easily available.

As is apparent for the skilled person, a MOF can comprise more than one metal ion or more than one ligand, i.e. there is a great number of variations possible which enables the skilled person to tailor the MOF in accordance with the specific needs in a specific situation. As long as the organic ligands and the metal ions form the network as in a MOF, there is no specific limitation in the starting materials.

MOF, depending on the starting materials used can also provide different functionalities at the same time which might be desirable in specific applications. This provides unique opportunities for providing nanostructured materials with combined multiple functionalities using a simple synthesis instead of complicated multi-step procedures.

From the foregoing it becomes apparent that hydroxides, nitrates and acetates of copper, iron or nickel, in particular copper or nickel and particularly of copper are preferred metal salts used for the synthesis of the MOF useful in the process of the present invention.

The organic ligand may be any at least bidentate ligand capable of binding to at least two metal ions, comprising an organic substructure with at least one functional group attached to it.

The organic substructure preferably has at least one of an alkyl group having from 1 to 10 carbon atoms or of an aryl group substructure having from 1 to 5 cycloalkyl, heterocycloalkyl, aryl or heteroaryl rings comprising from 5 to 20 ring atoms, which ring system may comprise fused rings. The capability to bind to at least two metal ions in the structure is achieved through the presence of at least one functional group. If only one functional group is present, same has to be multidentate to provide the required binding capability. If more than one functional group is present, same may be monodentate, multidentate or a combination of both.

Suitable ligands have been described in a multiplicity of publications of Prof. Yaghi et al, whose working group has been working on MOF for many years.

Preferred functional groups are selected from the group consisting of COOH, CS₂H, NO₂, SO₃H, Si(OH)₃, Ge(OH)₃, Sn(OH)₃, Si(SH)₄, Ge(SH)₄, POSH, PO₃H₂, AsO₃H, AsO₄H, P(SH)₃, As(SH)₃, CH(SH)₂, C(SH)₃, CH(NH₂)₂, C(NH₂)₃, CH(OH)₂, C(OH)₃, CH(CN)₂, C(CN)₃, CH(RSH)₂, CRSH)₃, CH(RNH₂)₂, C(RNH₂)₃, CH(ROH)₂, C(ROH)₃, CH(RCN)₂, and C(RCN)₃, wherein R is an alkyl group having from 1 to 5 carbon atoms or an aryl group having from 1 to 2 phenyl rings, CH(SH)₂, C(SH)₃, CH(NH₂)₂, C(NH₂)₃, CH(OH)₂, C(OH)₃, CH(CN)₂ and C(CN)₃.

Examples of suitable organic ligands, named here with carboxylic groups representative for the functional groups listed above include, without being limited thereto, oxalic acid, ethyloxalic acid, fumaric acid, 1,3,5-benzene tricarboxylic acid, 1,4-benzene dicarboxylic acid, 2,6-naphthalene dicarboxylic acid, 2,2′-bipyridyl-5,5′-dicarboxylic acid, adamantane tetracarboxylic acid, dihydroxyterepthalic acid, pyrazine dicarboxylic acid, benzene tetracarboxylic acid, nicotinic acid, and terphenyldicarboxylic acid.

A particularly preferred group of MOF useful in the process of the present invention is novel and such MOF per se constitute another embodiment of the present invention.

The novel MOF in accordance with the present invention comprise α-substituted bisphosphonic acids as organic ligands. The bisphosphonic acid group is a multidentate ligand of general formula (PO₃H₂)₂ and the ligands in accordance with the present invention comprise at least two phosphonic acid groups attached to an organic substructure as explained in more detail below, which preferably comprises at least one aryl or heteroaryl ring having from 5 to 20 ring atoms.

Particularly preferred are bisphosphonic acid having the general formula

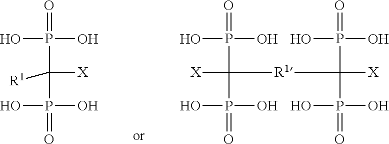

wherein R¹ is selected from the group consisting of C₂-C₁₈ alkyl, C₂-C₁₈-alkenyl or C₂-C₁₈-alkynyl groups, which may be substituted or unsubstituted and in which one or more carbon atoms may be replaced by a heteroatom selected from O, N and S, 5 to 20-membered membered cycloalkyl or aryl or 5- to 20-membered heteroaryl comprising at least one heteroatom selected from S, O or N, wherein the ring systems may be substituted or unsubstituted or may be annealed with one or more other ring systems, C₁-C₈-alkylaryl or C₁₀₈ heteroaryl alkyl and X is selected from hydrogen, halogen, OR², NR³R⁴, SR⁵, CR⁶R⁷R⁸ where R² to R⁵ independently of each other may be hydrogen, C₁-C₁₈ alkyl, C₁-C₈ arylalkyl or C₁-C₈ heteroarylalkyl, 5 to 20-membered membered cycloalkyl or aryl or 5- or 6-membered heteroaryl rings comprising at least one heteroatom selected from S, O or N and R⁶ to R⁸, independently of each other, may have the meanings as defined for R¹ above or may be a carbonyl group, or X may be CN.

R¹′ is a divalent group linking two bisphosphonic acid groups and is derived from R¹.

Preferred C₂ to C₁₈ alkyl groups are C₂ to C₈ alkyl, in particular ethyl, propyl, butyl, pentyl, hexyl, heptyl or octyl.

Preferred C₂ to C₁₈ alkenyl groups are C₂ to C₈ alkenyl groups, in particular ethenyl, propenyl, butenyl, pentenyl, hexenyl, heptenyl and octenyl.

Preferred C₂ to C₁₈ alkynyl groups are C₂ to C₈ alkynyl groups, in particular ethynyl, propynyl, butynyl, pentynyl, hexynyl, heptynyl and octynyl.

Preferred examples of cyclic ring systems as R¹ are 5- or 6-membered aryl or heteroaryl groups, in particular heteroaryl groups like

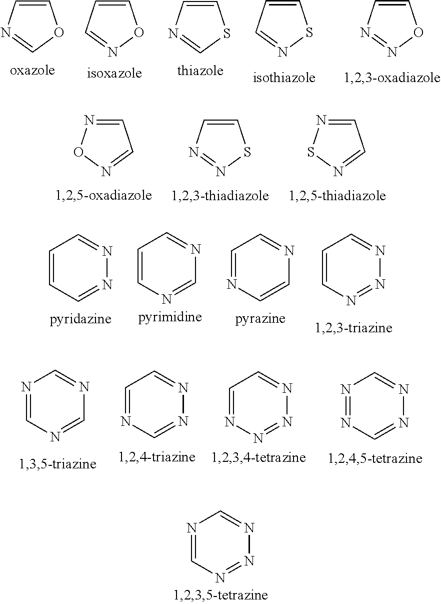

which may be substituted or unsubstituted.

Preferred substituents R² to R⁸ in the group X are as defined above for R¹ or hydrogen.

Particularly preferred substituents X are selected from Halogen, OR² and NR³R⁴ or CN, especially particular F, OH, NH₂ and CN.

A preferred group of bisphosphonic acids in the novel MOF in accordance with the present invention is reproduced below

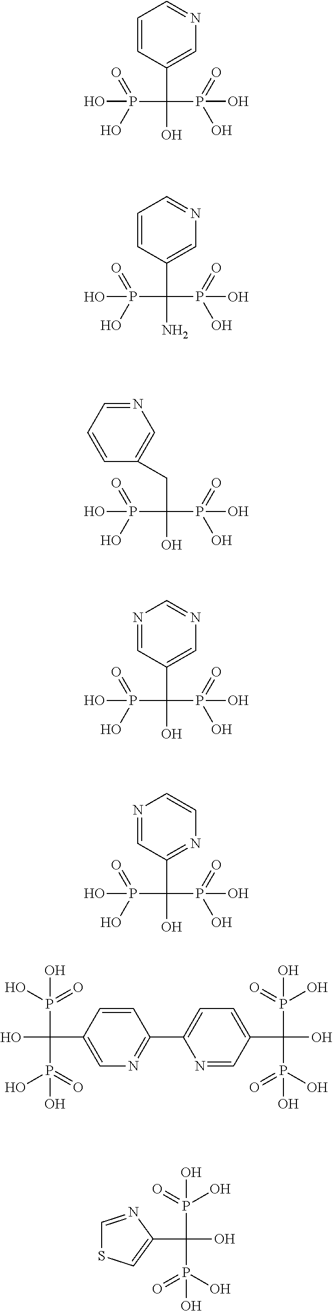

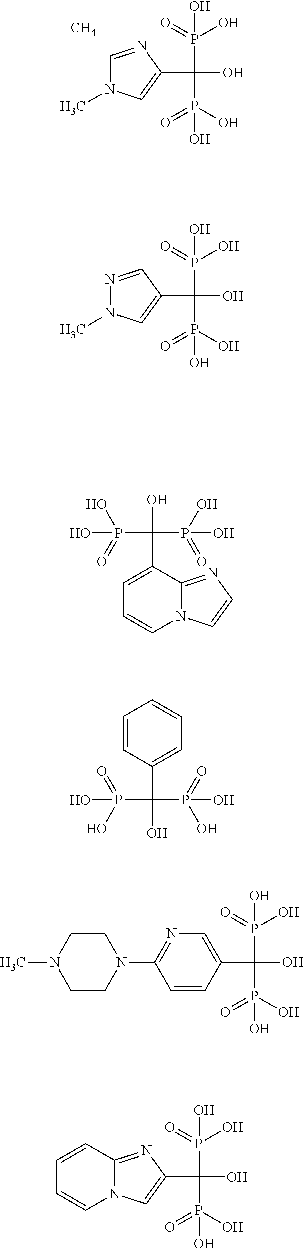

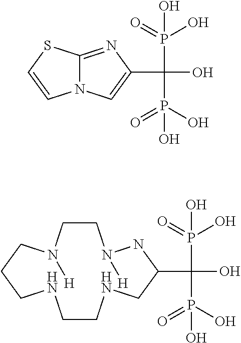 [SMILES: O=P(O)(O)C(O)(c1cn2ccsc2n1)P(=O)(O)O ; O=P(O)(O)C(O)(C1CNCCNCCCNCCNN1)P(=O)(O)O]

of which the following are especially preferred

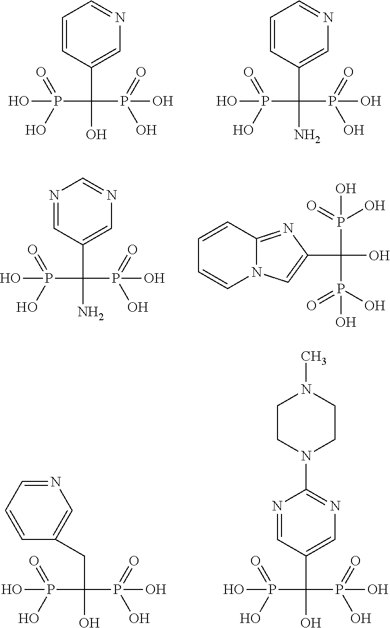

It has been found that heteroaryl residues in the bisphosphonic acids are generally preferred over aryl rings as they provide often a better performance in the carbon dioxide reduction.

What has been said before for MOF in general is also true for the novel MOF in accordance with the present invention.

The novel MOF can comprise more than one metal ion or more than one organic ligand, i.e. there is a great number of variations possible which enables the skilled person to tailor the MOF in accordance with the specific needs in a specific situation. As long as the organic ligands and the metal ions form the network as in a MOF, there is no specific limitation in the starting materials. Mixtures of bisphosphonic acids and other organic ligands are suitable and possible as well as mixtures of different bisphosphonic acids as ligands or mixtures of organic ligands with mixtures of bisphosphonic acids or mixtures of bisphosphonic acids and other organic ligands.

The bisphosphonic acids of the MOF in accordance with the present invention can e.g. be obtained by the reaction of acid halides, preferably acid chlorides, with phosphites, e.g. tris(trimethylsilyl) phosphite, either in a solution of the reactants or in a solution with an appropriate solvent, e.g. THF. The preparation of bisphosphonic acid is completed by treating the reaction mixture with an alcohol, e.g. methanol. The skilled person knows respective procedures so that no detailed description is necessary here. Furthermore, in the examples hereinafter the synthesis of a significant number of phosphonic acids for the novel MOF in accordance with the present invention is described in detail, so that reference can be made thereto here.

The metal ions in the novel MOF in accordance with the present invention can be selected from those metals and metal compounds described hereinbefore for MOF in general, with copper and nickel being particularly preferred metals.

The MOF useful for the process in accordance with the instant invention, including the novel MOF described hereinabove, can be prepared following synthesis routes known per se to the skilled person.

The MOF construction can be effected in solution, typically in an organic solvent or water, using a soluble metal compound and the organic ligand in a molar ratio of from 0.5 to 10:1 (metal compound to organic ligand), preferably 1:1 to 7:1 and particularly preferred 1.5:1 to 5:1. The solution is heated to a temperature of from 60 to 150° C., preferably 70 to 130° C. and particularly preferred 80 to 120° C. for a period of up to 96 hours, preferably 0.25 to 48 hours and more preferably from 0.5 to 24 h during which the MOF is formed.

For the synthesis of the novel MOF in accordance with the present invention, comprising the bisphosphonic acid ligands, procedures A to D described below are explicitly mentioned as representative and preferred synthesis routes:

Method A: The bisphosphonic acid is placed in a flask, water is added whereby a suspension is usually formed. The suspension is heated to a temperature of up to 100° C. and a solution of the metal salt is added. After the addition of the metal salt, an alkali metal hydroxide (a base) in an amount of appr. one equivalent, relative to the metal compound, is added and the mixture heated under reflux for a period of from 0.5 to 5 h. After cooling and washing with water until the washings are neutral, the solid material obtained can be dried and used in the process in accordance with the invention.

Method B: Corresponds to method A but without the addition of an alkali metal hydroxide.

Method C: As in method A but addition of the alkali metal hydroxide prior to the addition of the metal salt.

Method D: As method C, but using a microwave oven as reactor instead of heating.

Further details concerning the synthesis of novel MOF in accordance with the present invention can be taken from the examples hereinafter.

In accordance with the process of the present invention, carbon dioxide is reduced electrochemically using MOF as electrocatalysts.

Principally, the reduction could be carried out in aqueous as well as in organic solution; due to the better stability of MOF in organic solution, the reduction in an organic solvent is usually preferred. However, if the MOF provides sufficient stability in aqueous solution, aqueous media are as well suited.

Without being limited thereto, dimethyl formamide and acetonitrile may be mentioned as two examples of organic solvents, with acetonitrile yielding better results under certain conditions, in particular if novel MOF as described above are used.

The electrochemical properties of the MOF systems are described in more detail in the examples hereinafter.

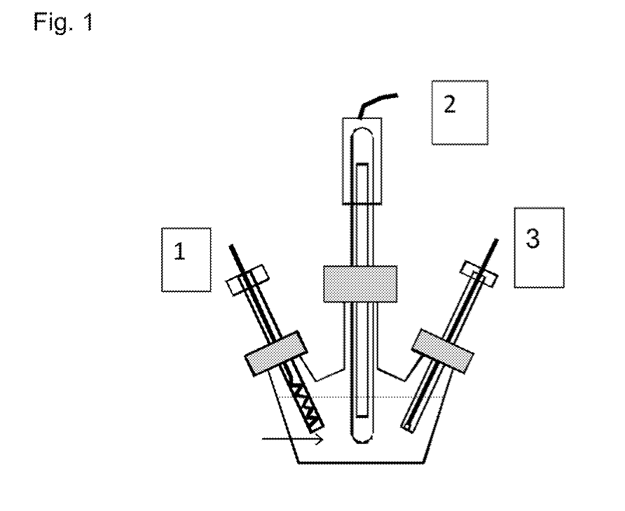

FIG. 1 shows a cell set-up used in the working examples.

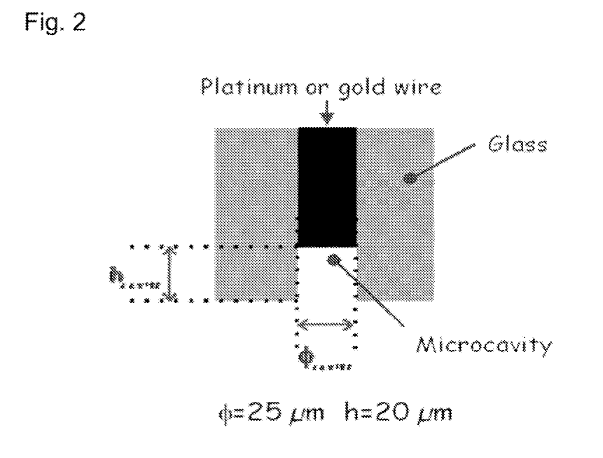

FIG. 2 shows the construction of the working electrode in the cell of FIG. 1.

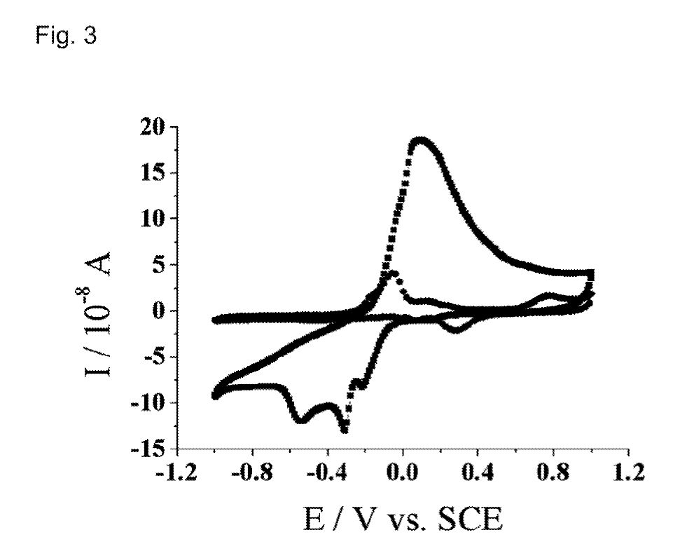

FIG. 3 shows a cyclovoltammogram of a material active in the reduction of carbon dioxide.

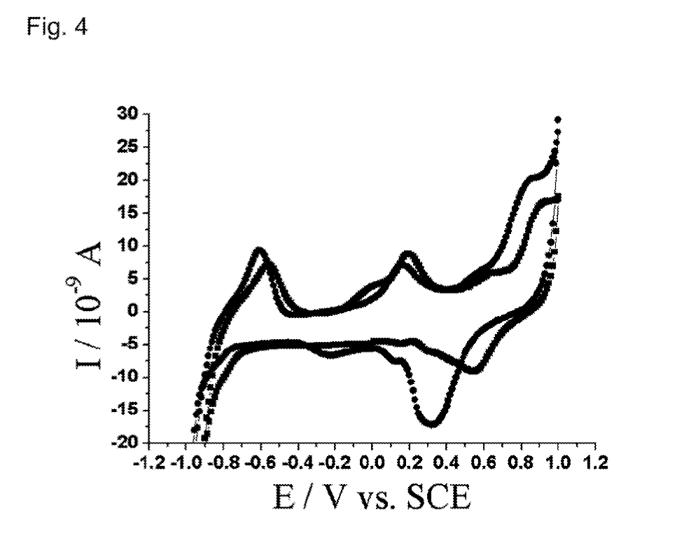

FIG. 4 shows a cyclovoltammogram of an inactive material.

FIG. 1 shows a Pyrex cell with 3 electrodes. Gold or platinum wire was used as counter electrode 1, a saturated calomel electrode 2 (E=+0.245 V vs. standard hydrogen electrode) as reference electrode and a gold cavity microelectrode (Au-CME) as working electrode 3.

The construction of the working electrode 3 is shown in FIG. 2 in enlarged detail. A platinum or gold wire was placed between glass boundaries whereby a microcavity is formed, into which the material to be tested was inserted.

The MOF to be studied was inserted into the microcavity of the working electrode (in amount of usually 10⁻⁷ to 10⁻⁸ g). The powders were controlled and studied before and after the electrochemical experiment by microscopy to be able to follow structural changes or modifications during the reaction.

The cell was saturated with N₂ (in the reference examples) respectively carbon dioxide by bubbling the respective gas for 20 minutes in the electrolyte used which was 1 m NaHCO₃ in the working examples shown hereinafter. During the experiment bubbling with the respective gas was maintained at a lower rate than the rate used for initial saturation. Voltametries were conducted using a computer controlled potentiostat (Manufacturer Autolab, Model PGSTAT 30).

Cyclovoltammetric measurements were taken by applying an electrical potential from E=0V to the negative values of about E=−1.2V. Subsequently, the potential was increased gradually to the positive values to about V=+1.2V. Subsequently, the potential was returned to E=0V thus closing the cycle. The curves show a dependence between E and the current I. When a reaction occurs at a given potential E, the current I flows and is recorded as a signal. The signals at E<0V indicate a reduction, while those at E>0V are the signals of oxidation processes taking place at the electrode. Active compounds are those which have a voltage V vs. current I profile of the reduction curve (for E<0) under CO₂ significantly different from the respective profile under N₂. FIG. 3 shows a cyclovoltammogram of an active catalyst, i.e. an where a reaction involving carbon dioxide takes place whereas FIG. 4 shows a respective CV where no reaction takes place.

It has to be noted, that albeit cyclovoltammetry measurements are very convenient primary screening means to determine catalytic activity as such, they show only electrical characteristics of the system without information about products of the electrochemical reactions.

The process in accordance with the present invention provides improved efficiencies for carbon dioxide production compared to previously described electrochemical processes of this type.

The electrochemical reduction of carbon dioxide can provide a significant number of different products and thus it is also important to achieve a good selectivity towards the desired reaction products.

Carbon monoxide is one desired reaction product as its mixture with hydrogen (syngas) can be used in commercially well developed processes for the manufacture of fuels.

The novel MOF in accordance with the present invention have proven to be particularly efficient catalysts for the conversion of carbon dioxide to carbon monoxide with good efficiency and selectivity which opens up new possibilities for storage of energy combined with reduction of carbon dioxide released to the atmosphere. A mixture of carbon monoxide and hydrogen, commonly known to the skilled person as syngas can be used for the synthesis of various new fuels which would represent a new energy source independent of fossil fuels.

It is conceivable to use solar energy for producing the electric current necessary to reduce the carbon dioxide to carbon monoxide and thus the new process and the MOF provide a way of basically converting electrical energy produced by photovoltaic systems into another form of useful energy which can be stored and made available during times where photovoltaic systems are not efficient in producing electrical energy. Overall, this could lead to a much better usage of the solar energy than is possible at the moment. This way, regenerative energies could contribute to a significantly higher degree to the energy needs of industry and private households, which would help to solve one of the challenges of the future.

The following examples show preferred embodiments of the process in accordance with the present invention and of the novel MOF.

### Step 1

### Manufacture of Selected Bisphosphonic Acids

### Example 1

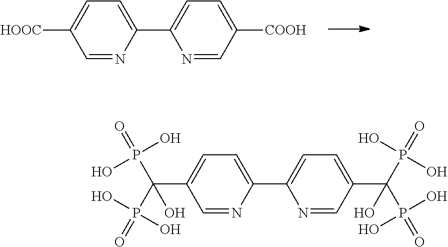 [SMILES: O=C(O)c1ccc(-c2ccc(C(=O)O)cn2)nc1 ; O=P(O)(O)C(O)(c1ccc(-c2ccc(C(O)(P(=O)(O)O)P(=O)(O)O)cn2)nc1)P(=O)(O)O]

Bispyridine dicarboxylic acid (1.0 g, 4.09 mmol) was added to thionyl chloride (10 mL). The mixture was refluxed for 19 h. Excess of thionyl chloride was removed from the reaction mixture by evaporation to get 1.06 g of diacid chloride. Tris(trimethylsilyl)phosphite (6.79 g, 7.6 mL, 22.8 mmol) was added to the diacid chloride and stirred at 35° C. for 60 h. The excess reagents were removed by evaporation and treated with methanol (25 mL) and stirred for 24 h. The precipitated product was collected by filtration. Yield=1.0 g (50%)

### Example 2

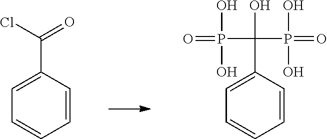 [SMILES: O=C(Cl)c1ccccc1 ; O=P(O)(O)C(O)(c1ccccc1)P(=O)(O)O]

Tris(trimethyl silyl)phosphite (2.98 g, 3.5 mL, 10 mmol) was added to anhydrous THF (5 mL). The mixture was cooled to 0-5° C. The acid chloride (700 mg, 0.58 mL, 5 mmol) was added dropwise to the above mixture. After the addition the cooling bath was removed and the reaction mixture was stirred at 35° C. for 48 h. The excess reagents were removed by evaporation and treated with methanol (25 mL) and stirred for 24 h. Solvents were removed by evaporation. The residue was dissolved in water (25 mL) and extracted with ethyl acetate (25 mL). The aqueous layer was evaporated to dryness. Yield=225 mg (17%) ¹H NMR (D₂O; 400 MHz): δ 8.76-8.68 (m, 1H), 8.11-8.02 (m, 2H), 7.77-7.70 (m, 2H) ³¹P NMR (D₂O, 121.5 MHz): δ=14.90.

### Example 3

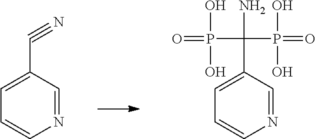 [SMILES: N#Cc1cccnc1 ; NC(c1cccnc1)(P(=O)(O)O)P(=O)(O)O]

Phosphorus acid (820 mg, 10 mmol) was added to PCl₃ (4.2 g, 30 mmol). 3-cyano pyridine (1.04 g, 10 mmol) was added to the above clear solution to get a white precipitate. It was heated at 75° C. for overnight, cooled to room temperature and water (15 mL) was added to it. The temperature rose to 95° C. and the mixture was diluted with water (25 mL) and filtered. The filtrate was evaporated to dryness, the residue was triturated with methanol (10 mL) and filtered. The solid was again triturated with water (10 mL) and filtered and dried. Yield=400 mg (15%) ¹H NMR (D₂O; 400 MHz): δ 8.66 (s, 1H), 8.10 (d, 2H, J=4.92 Hz), 7.99 (d, 1H, J=8.35 Hz) 7.19-7.07 (m, 1H) ³¹P NMR (D₂O, 121.5 MHz): δ=17.1.

### Example 4

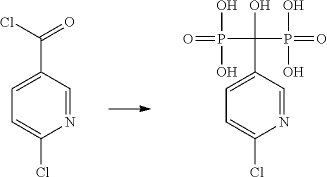 [SMILES: O=C(Cl)c1ccc(Cl)nc1 ; O=P(O)(O)C(O)(c1ccc(Cl)nc1)P(=O)(O)O]

Tris(trimethyl silyl) phosphite (2.98 g, 3.5 mL, 10 mmol) was added to anhydrous THF (5 mL). The mixture was cooled to −28° C. The acid chloride (875 mg, 5 mmol) was added to the above mixture. After the addition cooling bath was removed and stirred at 36° C. for 48 h. The excess reagents were removed by evaporation and treated with methanol (25 mL) and stirred for 24 h. Solvents were removed by evaporation. The residue was triturated with methanol (25 mL) and filtered. Yield=1.17 g (77%) ¹H NMR (D₂O; 400 MHz): δ 8.51 (bs, 1H), 8.08 (d, 1H J=8.01 Hz), 7.23 (d, 1H, J=10.69 Hz) ³¹P NMR (D₂O, 121.5 MHz): δ=14.81.

### Example 5

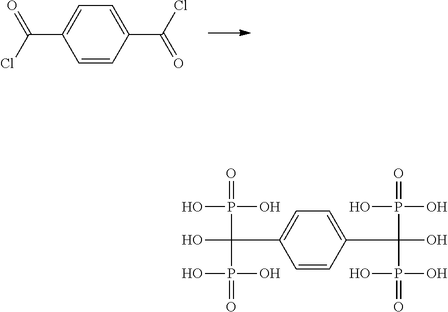 [SMILES: O=C(Cl)c1ccc(C(=O)Cl)cc1 ; O=P(O)(O)C(O)(c1ccc(C(O)(P(=O)(O)O)P(=O)(O)O)cc1)P(=O)(O)O]

Tris(trimethyl silyl)phosphite (5.98 g, 7 mL, 20 mmol) was cooled to 0 to 5° C. and acid chloride (1.01 g, 5 mmol) added to it. The mixture was brought to room temperature over 1 h and then heated at 36° C. for two days. The excess reagents were removed by evaporation and treated with methanol (25 mL) and stirred for 24 h. Solvents were removed by evaporation. The residue was triturated with methanol (25 mL) and filtered. Yield=1.48 g (64%)

### Example 6

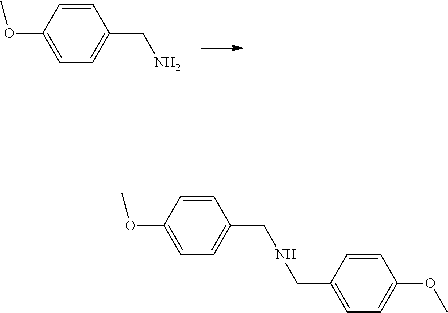

4-methoxy benzyl amine (4.0 g, 29.16 mmol) was added to a solution of 4-methoxy benzyl aldehyde (4.0 g, 29.16 mmol) in ethanol (60 mL). The mixture was heated under reflux for 2 h and stirred at room temperature for 19 h. Solvents were removed by evaporation and the residue was dissolved in methanol (50 mL), cooled to −10° C. sodium borohydride (1.1 g, 29.16 mmol) added to it. The mixture was stirred for 19 h at room temperature and evaporated to dryness. The residue was dissolved in dichloromethane (100 mL) and washed with 5% sodium bicarbonate solution (50 mL). Thereafter, the organic layer was dried over sodium sulfate and filtered and evaporated to dryness. The dibenzyl amine was used without further purification. Yield=6.7 g (90%) m/z 258

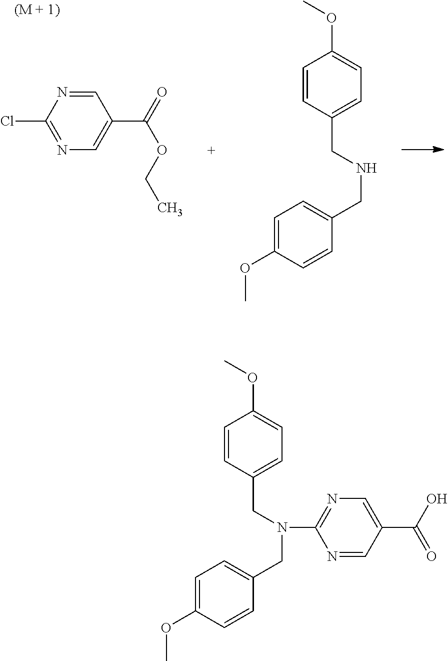 [SMILES: CCOC(=O)c1cnc(Cl)nc1 ; COc1ccc(CNCc2ccc(OC)cc2)cc1 ; COc1ccc(CN(Cc2ccc(OC)cc2)c2ncc(C(=O)O)cn2)cc1]

Chloro pyrimidine ester (558 mg, 3 mmol) was dissolved in ethanol (15 mL) along with 4-methoxy-dibenzyl amine (771 mg, 3 mmol). Potassium carbonate was added to this mixture and heated under reflux for 19 h. Solvents were evaporated to dryness. The residue was purified by Combiflash, 40 g column, eluting with 10-50% ethyl acetate in heptanes. Yield=1.1 g (90%) m/z 408 (M+1). The ester obtained in this first step was dissolved in ethanol (15 mL) and kept under stirring. To this solution was added a solution of sodium hydroxide (120 mg, 3 mmol) in water (3 mL). The mixture was stirred at room temperature for overnight. Solvents were removed by evaporation and the residue was dissolved in water (50 mL) and extracted with ethyl acetate (50 mL). The aqueous layer was acidified to pH1.5 (1 mL concentrated hydrochloric acid added). The precipitate obtained was filtered and dried. Yield=1.1 g (100%) ¹H NMR (DMSO-d6; 400 MHz): δ 9.00 (s, 2H), 7.21 (d, 4H, J=8.76 Hz), 6.88 (d, 4H, J=8.76 Hz), 4.87 (s, 4H), 3.83 (s, 6H).

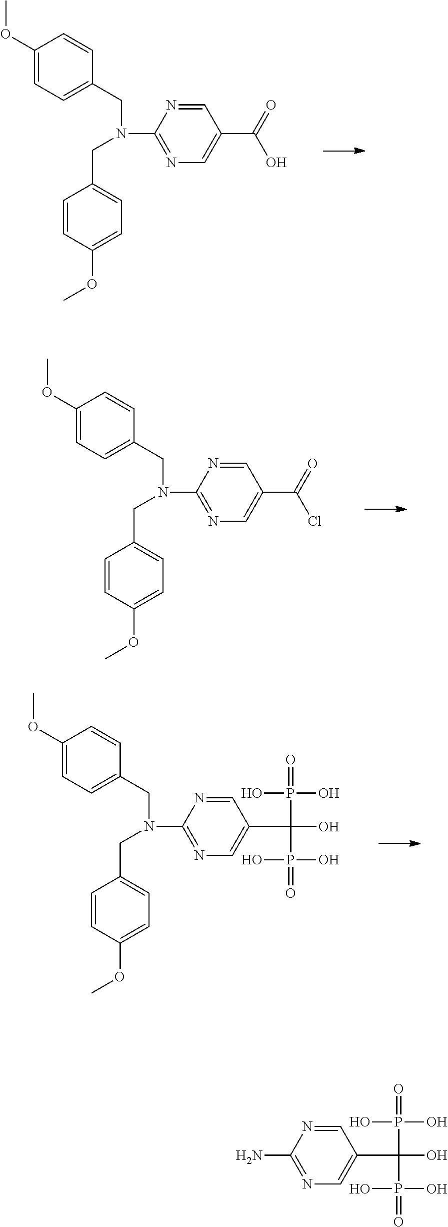 [SMILES: COc1ccc(CN(Cc2ccc(OC)cc2)c2ncc(C(=O)O)cn2)cc1 ; COc1ccc(CN(Cc2ccc(OC)cc2)c2ncc(C(=O)Cl)cn2)cc1 ; COc1ccc(CN(Cc2ccc(OC)cc2)c2ncc(C(O)(P(=O)(O)O)P(=O)(O)O)cn2)cc1 ; Nc1ncc(C(O)(P(=O)(O)O)P(=O)(O)O)cn1]

Thionyl chloride (25 mL) was added to the acid (1.1 g, 2.7 mmol) and heated under reflux for 3 h. Excess thionyl chloride was removed by evaporation. Anhydrous dichloromethane (20 mL) was added to the mixture and evaporated to dryness. Acid chloride was dissolved in anhydrous tetrahydrofuran (5 mL) and cooled to 0 to 5° C. Tristrimethyl silyl phosphite (2.98 g, 3.5 mL, 10 mmol) was added drop wise to it. The mixture was stirred at room temperature for 1 h and at 36° C. for 24 h. Volatiles were removed by evaporation and the residue was dissolved in methanol (20 mL), stirred at 36° C. for 24 h. Solvents were removed and the residue was triturated with anhydrous methanol (10 mL) and filtered and dried. Yield=880 mg (62%) ¹H NMR (D₂O; 400 MHz): δ 8.64 (s, 2H), 7.16 (d, 4H, J=7.00 Hz), 6.88 (d, 4H, J=7.00 Hz), 4.69 (s, 4H), 3.78 (s, 6H) ³¹P NMR (D₂O, 121.5 MHz): δ=15.31.

The N protected bis phosphonic acid (592 mg, 1.13 mmol) was taken in 6N hydrochloric acid (10 mL) and heated under reflux for overnight. Analysis of the reaction by mass spectrum indicated the formation of product. Heating was discontinued and the mixture was brought to room temperature. The mixture was extracted with dichloromethane (2×10 mL) and the aqueous layer was evaporated to dryness. Yield=262 mg. ³¹P NMR (D₂O, 121.5 MHz): δ=15.41 (minor) and 14.63 (major).

### Example 7

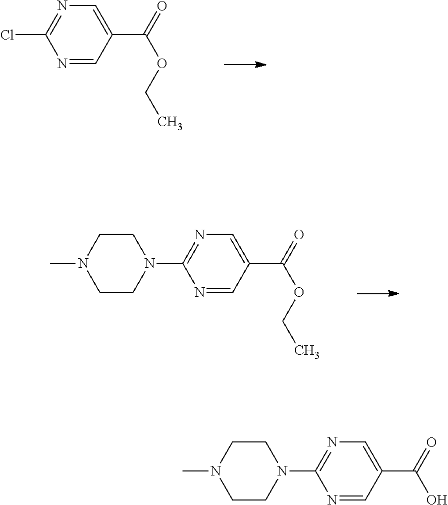 [SMILES: CCOC(=O)c1cnc(Cl)nc1 ; CCOC(=O)c1cnc(N2CCN(C)CC2)nc1 ; CN1CCN(c2ncc(C(=O)O)cn2)CC1]

Methyl piperazine (300 mg, 3 mmol) was charged to a flask followed by ethanol (15 mL). To this solution chloro compound (558 mg, 3 mmol) and potassium carbonate (414 mg, 3 mmol) were charged. The mixture was then heated at 75-85° C. for two hours. TLC (20% methanol in ethyl acetate) showed the formation of the product with complete disappearance of the starting chloro compound. Cooled to room temperature and evaporated to dryness. The residue was then purified by combiflash (40 g column) eluting with 0-100% methanol in ethyl acetate. Fractions were identified by TLC and mass spectral analysis. Yield=630 mg (84%). ¹H NMR (DMSO-d6; 400 MHz): δ 8.80 (s, 2H), 4.27 (q, 2H, J=8.00 Hz), 3.88-3.82 (m, 4H), 2.42-234 (m, 4H), 3.23 (s, 6H), 1.29 (t, 3H, J=7.44 Hz). The ester (630 mg, 2.52 mmol) from the first step was taken in ethanol (10 mL). A solution of sodium hydroxide (120 mg, 3 mmol) in water (5 mL) added drop wise to the above solution. The mixture was then stirred at room temperature for 19 h. Mass spectrum showed the formation of product (M+1 at 223). Solvents were removed by evaporation. The residue was acidified to pH 2. Solids were separated out and collected by filtration. The aqueous layer was lyophilized. Combined weight of the product was 600 mg (90%). ¹H NMR (DMSO-d6; 400 MHz): δ 8.86 (s, 2H), 4.80 (bs, 2H), 3.88-2.88 (m, 8H), 2.77 (s, 3H).

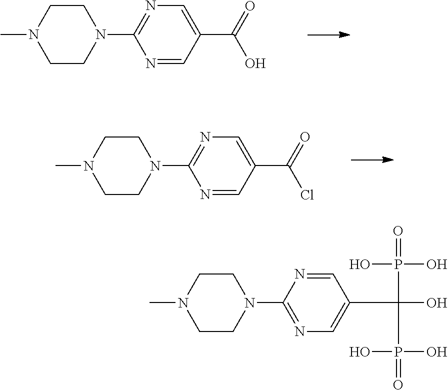 [SMILES: CN1CCN(c2ncc(C(=O)O)cn2)CC1 ; CN1CCN(c2ncc(C(=O)Cl)cn2)CC1 ; CN1CCN(c2ncc(C(O)(P(=O)(O)O)P(=O)(O)O)cn2)CC1]

Thionyl chloride (10 mL) was added to the acid (600 mg, 2.7 mmol) and heated under reflux for 3 h. Cooled to room temperature and the excess thionyl chloride were removed by evaporation. Anhydrous dichloromethane (20 mL) was added to the mixture and evaporated to dryness. Acid chloride was dissolved in anhydrous tetrahydrofuran (10 mL) and cooled to 0 to 5° C. Tristrimethyl silyl phosphite (4.47 g, 5 mL, 15 mmol) was added drop wise to it. The mixture was stirred at room temperature for 1 h and at 36° C. for 48 h. Volatiles were removed by evaporation and the residue was dissolved in methanol (20 mL), stirred at 36° C. for 24 h. Solvents were removed and the residue was triturated with anhydrous methanol (10 mL) and filtered and dried. Yield=305 mg (31%) ¹H NMR (D₂O; 400 MHz): δ 8.49 (s, 2H), 3.86-3.17 (m, 4H), 2.60-2.12 (m, 4H), 2.12 (s, 3H) ³¹P NMR (D₂O, 121.5 MHz): δ=16.0.

### Example 8

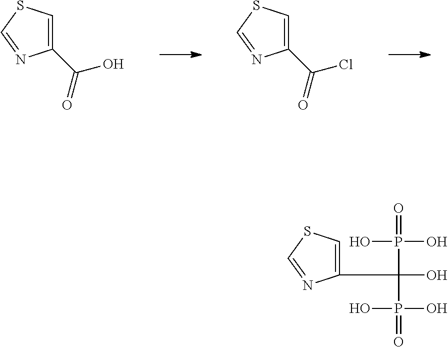 [SMILES: O=C(O)c1cscn1 ; O=C(Cl)c1cscn1 ; O=P(O)(O)C(O)(c1cscn1)P(=O)(O)O]

Thionyl chloride (10 mL) was added to the acid (650 mg, 5 mmol) and heated under reflux for 1 h. Thereafter the reaction mixture was cooled to room temperature and the excess thionyl chloride was removed by evaporation. Anhydrous dichloromethane (20 mL) was added to the mixture and evaporated to dryness. Acid chloride was dissolved in anhydrous tetrahydrofuran (10 mL) and cooled to 0-5° C. Tris(trimethyl silyl) phosphite (4.47 g, 5 mL, 15 mmol) was added dropwise. The mixture was stirred at room temperature for 1 h and at 36° C. for 20 h. Volatiles were removed by evaporation and the residue was dissolved in methanol (20 mL) and stirred at 36° C. for 20 h. Solvents were removed and the residue was triturated with anhydrous methanol (10 mL) and filtered and dried. Yield=1.33 g (96%) ¹H NMR (D₂O; 400 MHz): δ 9.23 (s, 1H), 7.68 (s, 1H) ³¹P NMR (D₂O, 121.5 MHz): δ=13.8.

### Example 9

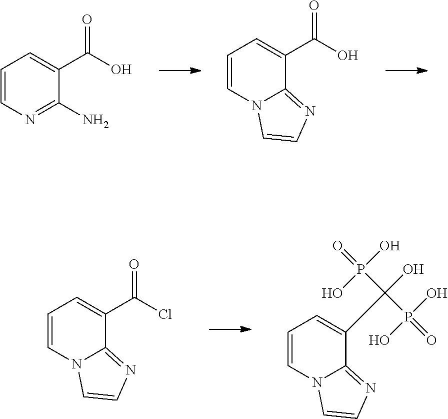 [SMILES: Nc1ncccc1C(=O)O ; O=C(O)c1cccn2ccnc12 ; O=C(Cl)c1cccn2ccnc12 ; O=P(O)(O)C(O)(c1cccn2ccnc12)P(=O)(O)O]

Chloroacetaldehyde (6 g, 4.8 mL) was added to a solution of 2-aminonicotinic acid (10 g, 72.46 mmol) in ethanol (100 mL). The mixture was heated under reflux for 19 h. Additional chloroacetaldehyde (5 mL) added and heating continued for additional 20 h. The reaction mixture was cooled to room temperature and filtered, washed with methanol and dried. Yield=8 g (68%) ¹H NMR (DMSO-d6; 400 MHz): δ 14.43 (bs, 1H), 9.25 (dd, 1H), 8.61 (d, 1H, J=2.21 Hz), 8.48 (dd, 1H), 8.14 (d, 1H, J=2.2 Hz), 7.62 (t, 1H, J=7.07 Hz).

Thionyl chloride (10 mL) was added to the acid (810 mg, 5 mmol) and heated under reflux for 1 h, thereafter cooled to room temperature and the excess thionyl chloride was removed by evaporation. Anhydrous dichloromethane (20 mL) was added to the mixture and evaporated to dryness. Acid chloride was dissolved in anhydrous tetrahydrofuran (10 mL) and cooled to 0-5° C. Tris(trimethyl silyl) phosphite (5.96 g, 6.6 mL, 20 mmol) was added dropwise. The mixture was stirred at room temperature for 1 h and at 36° C. for 20 h. Volatiles were removed by evaporation and the residue was dissolved in methanol (20 mL) and stirred at 36° C. for 20 h. Solvents were removed and the residue was triturated with anhydrous methanol (10 mL) and filtered and dried. Yield=460 mg (29%) ¹H NMR (D₂O; 400 MHz): δ 8.29-8.24 (m, 1H), 7.93-7.87 (m, 1H), 7.79 (d, 1H, J=2.1 Hz), 7.56 (d, 1H, J=2.0 Hz), 6.93 (t, 1H, J=7.3 Hz) ³¹P NMR (D₂O, 121.5 MHz): δ=16.1.

### Example 10

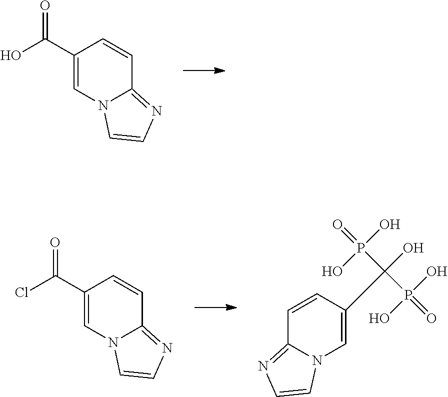 [SMILES: O=C(O)c1ccc2nccn2c1 ; O=C(Cl)c1ccc2nccn2c1 ; O=P(O)(O)C(O)(c1ccc2nccn2c1)P(=O)(O)O]

Thionyl chloride (10 mL) was added to the acid (810 mg, 5 mmol) and heated under reflux for 1 h. Cooled to room temperature and the excess thionyl chloride were removed by evaporation. Anhydrous dichloromethane (20 mL) was added to the mixture and evaporated to dryness. Acid chloride was dissolved in anhydrous tetrahydrofuran (10 mL) and cooled to 0-5° C. Tristrimethyl silyl phosphite (5.96 g, 6.6 mL, 20 mmol) was added drop wise to it. The mixture was stirred at room temperature for 1 h and at 36° C. for 20 h. Volatiles were removed by evaporation and the residue was dissolved in methanol (20 mL), stirred at 36° C. for 20 h. Solvents were removed and the residue was triturated with anhydrous methanol (10 mL) and filtered and dried. ³¹P NMR (D₂O, 121.5 MHz): multiple signals.

### Example 11

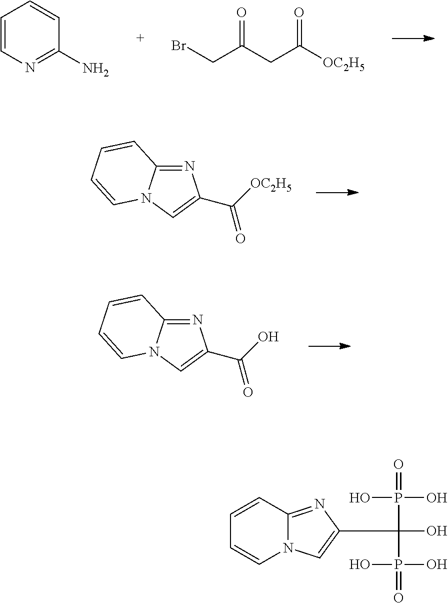 [SMILES: Nc1ccccn1 ; CCOC(=O)CC(=O)CBr ; CCOC(=O)c1cn2ccccc2n1 ; O=C(O)c1cn2ccccc2n1 ; O=P(O)(O)C(O)(c1cn2ccccc2n1)P(=O)(O)O]

To a solution of 2-amino pyridine (2.5 g, 26.6 mmol) in anhydrous tetrahydrofuran (60 mL) was added dropwise ethyl bromo pyruvate (5.16 g, 26.5 mmol, 3.3 mL). The resulting suspension was heated under reflux for 19 h, cooled to room temperature and filtered and dried. Yield=5.0 g (100%). ¹H NMR (DMSO-d6; 400 MHz): δ 10.57 (bs, 1H), 8.38 (d, 1H, J=6.46 Hz), 8.12-8.07 (m, 1H), 7.16-7.10 (m, 2H), 4.25 (q, 2H, J=7.15 Hz), 1.25 (t, 3H, J=7.37 Hz).

The ester (1.9 g, 10 mmol) was dissolved in ethanol (10 mL). To this stirred solution sodium hydroxide (140 mg, 11 mmol) in water (5 mL) was added. A clear solution was obtained. After stirring for one hour, the solid separated out. Additional water (20 mL) and 50% sodium hydroxide solution (1 mL) were added, the mixture was stirred overnight and evaporated to dryness. The residue was dissolved in water (5 mL) and acidified to pH 4.93. The separated solid was collected by filtration and then dried. Yield=760 mg (47%). ¹H NMR (D₂O; 400 MHz): δ 8.03 (d, 1H, J=8.11 Hz), 7.83 (s, 1H), 7.26 (d, 1H, J=9.27 Hz), 7.12-7.05 (m, 1H), 6.70-6.64 (t, 1H, J=7.3 Hz).

The acid (760 mg, 4.69 mmol) was taken in thionyl chloride (10 mL) and heated under reflux for one hour. After cooling to room temperature dichloromethane (15 mL) was added. The reaction mixture was evaporated to dryness. The residue was taken in anhydrous tetrahydrofurane (10 mL) and cooled to −20° C. and tris(trmethyl silyl)phosphite was added (11.9 g, 20 mmol, 13.3 mL) dropwise. The mixture was allowed to warm to room temperature and then stirred for 30 minutes. It was then heated at 50-55° C. for 24 h. All the solvents were removed by evaporation and the residue was taken in methanol (50 mL) and heated under reflux for 19 h. After cooling to room temperature the product was collected by filtration and drying. Yield=1.2 g (55%) ¹H NMR (D₂O; 400 MHz): δ 7.64-7.55 (m, 2H), 7.45-7.36 (m, 2H), 7.28 (s, 1H) ³¹P NMR (D₂O, 121.5 MHz): δ=15.19.

### Example 12

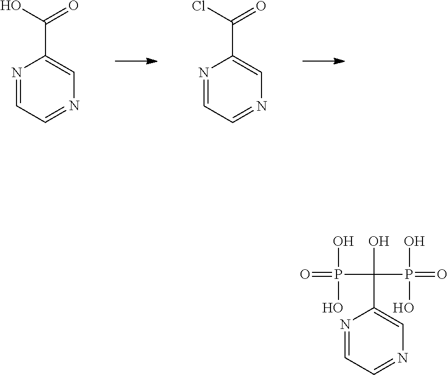 [SMILES: O=C(O)c1cnccn1 ; O=C(Cl)c1cnccn1 ; O=P(O)(O)C(O)(c1cnccn1)P(=O)(O)O]

The acid (1.24 g, 10 mmol) was taken in thionyl chloride (10 mL) and heated under reflux for one hour. Cooled to room temperature and dichloromethane (15 mL) added. It was evaporated to dryness. The residue was taken in anhydrous tetrahydro furan (10 mL) and cooled to −20° C. and tris trmethyl silyl phosphite added (11.9 g, 40 mmol, 13.3 mL) drop wise. The mixture was allowed to warm to room temperature and then stirred for 30 minutes. It was then heated at 35-40° C. for 70 h. All the solvents were removed by evaporation and the residue was taken in methanol (50 mL) and heated under reflux for 19 h. The mixture was cooled to room temperature and the product was collected by filtration. The solid thus obtained was taken in anhydrous methanol (35 mL) and heated under reflux for 4 h and filtered and dried. Yield=1.2 g (45%) ¹H NMR (D₂O; 400 MHz): δ 9.16 (bs, 1H), 8.54 (bs, 1H), 8.37 (bs, 1H) ³¹P NMR (D₂O, 121.5 MHz): δ=14.03.

### Example 13

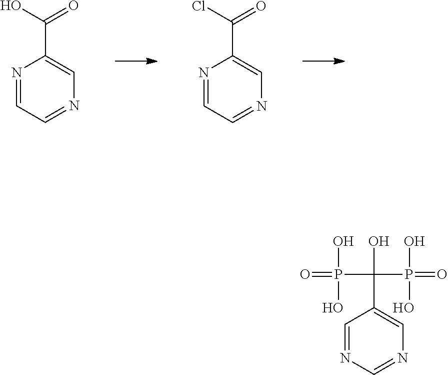 [SMILES: O=C(O)c1cnccn1 ; O=C(Cl)c1cnccn1 ; O=P(O)(O)C(O)(c1cncnc1)P(=O)(O)O]

The acid (3.72 g, 30 mmol) was taken in thionyl chloride (30 mL) and heated under reflux for one hour. After cooling to room temperature dichloromethane (25 mL) was added and it was evaporated to dryness. The residue was taken in anhydrous tetrahydrofurane (20 mL) and cooled to −20° C. and tris(trimethyl silyl) phosphite (30 g, 100 mmol, 33.3 mL) was added dropwise. The mixture was allowed to warm to room temperature and then stirred for 30 minutes. It was then heated at 35-40° C. for 70 h. All the solvents were removed by evaporation and the residue was taken in methanol (50 mL) and heated under reflux for 19 h. After cooling to room temperature the product was collected by filtration. The solid thus obtained was taken in anhydrous methanol (35 mL) and heated under reflux for 4 h. Filtered and dried. Yield=1.3 g (16%) ¹H NMR (D₂O; 400 MHz): δ 9.16-9.07 (m, 2H), 8.92-8.89 (m, 1H) ³¹P NMR (D₂O, 121.5 MHz): δ=14.45.

### Example 14

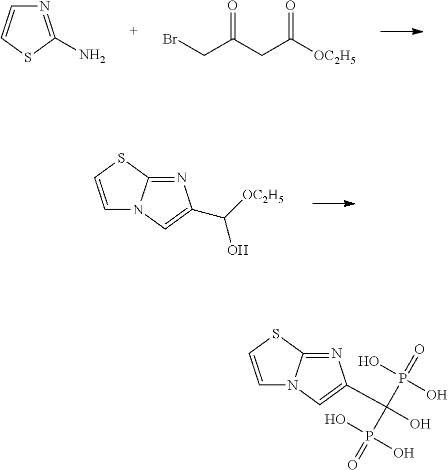 [SMILES: Nc1nccs1 ; CCOC(=O)CC(=O)CBr ; CCOC(O)c1cn2ccsc2n1 ; O=P(O)(O)C(O)(c1cn2ccsc2n1)P(=O)(O)O]

To a solution of 2-amino thiazole (2.0 g, 20 mmol) in anhydrous tetrahydrofuran (20 mL) ethyl bromo pyruvate (4.43 g, 20.2 mmol, 2.8 mL) was added dropwise. The resulting solution was stirred for 19 h, evaporated to dryness and then suspended in ethanol (70 mL) and refluxed for 3 h and evaporated to dryness. The residue was triturated with ethyl acetate and filtered and dried. Yield=4.0 g (100%). ¹H NMR (DMSO-d6; 400 MHz): δ 8.57 (s, 1H), 8.08 (d, 1H, J=4.38 Hz), 7.57 (d, 1H, J=4.63 Hz), 4.29 (q, 2H, J=7.32 Hz), 1.29 (t, 3H, J=7.15 Hz).

The ester (1.96 g, 10 mmol) was dissolved in ethanol (10 mL). To this stirred solution potassium hydroxide (1 g, 17.85 mmol) in water (5 mL) was added. The mixture was then heated under reflux for 3 h and thereafter evaporated to dryness. The residue was dissolved in water (5 mL) and acidified with concentrated hydrochloric acid (1.1 g). The separated solid was collected by filtration and then dried. Yield=1 g (59%). ¹H NMR (DMSO-d6; 400 MHz): δ 8.36 (s, 1H), 7.96 (d, 1H, J=4.42 Hz), 7.43 (d, 1H, J=4.47 Hz.

The acid (1 g, 5.95 mmol) was taken in thionyl chloride (10 mL) and heated under reflux for two hours. Thereafter it was cooled to room temperature and dichloromethane (15 mL) was added. It was evaporated to dryness. The residue was taken in anhydrous tetrahydrofurane (10 mL) and cooled to −20° C. and tris(trimethyl silyl) phosphite was added (7.1 g, 24 mmol, 8 mL) dropwise. The mixture was allowed to warm to room temperature and then stirred for 30 minutes. It was then heated at 50-55° C. for 48 h. All the solvents were removed by evaporation and the residue was taken in methanol (50 mL) and heated under reflux for 19 h. After cooling to room temperature the product was collected by filtration and drying. ³¹P NMR (D₂O, 121.5 MHz): multiple signals.

### Example 15

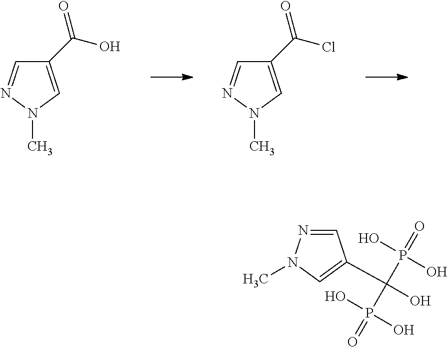

The acid (1.0 g, 7.9 mmol) was taken in thionyl chloride (10 mL) and heated under reflux for one hour. Cooled to room temperature and dichloromethane (10 mL) added. It was evaporated to dryness. The residue was taken in anhydrous tetrahydro furan (10 mL) and cooled to −20° C. and tris trimethyl silyl phosphite added (9.4 g, 31.7 mmol, 10.6 mL) drop wise. The mixture was allowed to warm to room temperature and then stirred for 30 minutes. It was then heated at 35-40° C. for 70 h. All the solvents were removed by evaporation and the residue was taken in methanol (50 mL) and heated under reflux for 19 h. It was then cooled to room temperature and the product was collected by filtration. The solid thus obtained was taken in anhydrous methanol (50 mL) and heated under reflux for 3 h. Filtered and dried. Yield=1.44 g (67%) ¹H NMR (D₂O; 400 MHz): δ ³¹P NMR (D₂O, 121.5 MHz): δ=14.03.

### Examples 16 to 49

### Synthesis of Novel Metal Organic Frameworks

There were four procedures used.

Procedure A, one equivalent of sodium hydroxide added. Procedure B no base added and procedure C, the base is added before the addition of copper (II) acetate. Under microwave conditions procedure D.

Procedure A: Bis phosphonic acid (0.5 mmol) was placed in a round bottom flask. Water (5 mL) added to it, a suspension obtained. The suspension was heated at 100° C. and a turbid solution was obtained. A solution of copper (II) acetate (2 mmol) in water (7.5 mL) was added dropwise during thirty minutes. After the addition of copper (II) acetate, sodium hydroxide solution (1N, 0.5 mL) was added and the mixture was heated under reflux for 1 h, cooled to room temperature and filtered. Washed with water until the washings were neutral followed by washing with methanol. The solid material was then dried.

Procedure B: Bis phosphonic acid (0.5 mmol) was placed in a round bottom flask. Water (5 mL) added to it, a suspension obtained. The suspension was heated at 100° C. and a turbid solution was obtained. A solution of copper (II) acetate (2 mmol) in water (7.5 mL) was added dropwise during thirty minutes. After the addition copper (II) acetate the mixture was heated under reflux for 1 h, cooled to room temperature and filtered. Washed with water until the washings were neutral followed by washing with methanol. The solid material was then dried.

Procedure C: Bis phosphonic acid (0.5 mmol) was placed in a round bottom flask. Water (5 mL) added to it, a suspension obtained. To this suspension sodium hydroxide solution (1N, 0.5 mL) was added and a clear solution was obtained. The solution was heated at 100° C., a solution of copper (II) acetate (2 mmol) in water (7.5 mL) was added dropwise during thirty minutes. After the addition of copper (II) acetate the mixture was heated under reflux for 1 h, cooled to room temperature and filtered. Washed with water until the washings were neutral followed by washing with methanol. The solid material was then dried.

Procedure D: Bisphosphonic acid (0.5 mmol) was placed in a micro wave reaction vessel. Water (3 mL) was added to it and a suspension was obtained. To this suspension metal acetate (2 mmol) was added followed by sodium hydroxide solution (1N, 0.4 mL). The mixture was subjected to microwave irradiation, cooled to room temperature and filtered. Washed with water until the washings were neutral followed by washing with methanol. The solid material was then dried.

MOF could be obtained for all of the bisphosphonic acids of examples 1 to 15 by following one of these routes.

The following table 1 lists certain MOF prepared using selected bisphosphonic acids of examples 1 to 15

TABLE 1

| | | Metal cpd. | | | | | | | | | |
|---|---|---|---|---|---|---|---|---|---|---|---|
| | | Type and | 1N | | | | pH | pH | | | |
| Ex. | Bisphosphonic acid, type and amount | amount | NaOH | | Water | | before | After | Yield | | Proc. |
| 16 | 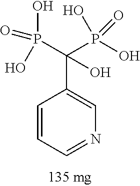 [SMILES: O=P(O)(O)C(O)(c1cccnc1)P(=O)(O)O] | Cu(OAc)₂ 400 mg | 0 | mL | 12.5 | mL | Not measured | 4.71 | 133 | mg | B |
| 17 | 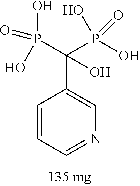 [SMILES: O=P(O)(O)C(O)(c1cccnc1)P(=O)(O)O] | Cu(OH)₂ 97.56 mg | 0 | mL | 12.5 | mL | Not measured | 6.81 | 308 | mg | B |
| 18 | 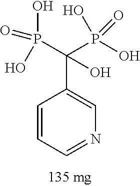 [SMILES: O=P(O)(O)C(O)(c1cccnc1)P(=O)(O)O] | Cu(OAc)₂ 400 mg | 0.5 | mL | 12.5 | mL | Not measured | 4.96 | 192 | mg | A |
| 19 | 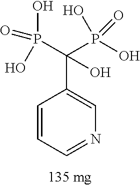 [SMILES: O=P(O)(O)C(O)(c1cccnc1)P(=O)(O)O] | Ni(OAc)₂ 1.0 g | 0.4 | mL | 3 | mL | 4.91 | 5.28 | 90 | mg | D |
| 20 | 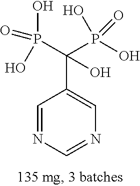 [SMILES: O=P(O)(O)C(O)(c1cncnc1)P(=O)(O)O] | Ni(OAc)₂ 1.0 g | 0.4 | mL | 3 | mL | 5.02 | 5.27 | 688 | mg | D |
| 21 | 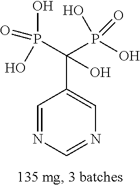 [SMILES: O=P(O)(O)C(O)(c1cncnc1)P(=O)(O)O] | Ni(OAc)₂ 1.0 g | 0.4 | mL | 3 | mL | 4.98 | 5.27 | 496 | mg | D |
| 22 | 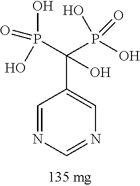 [SMILES: O=P(O)(O)C(O)(c1cncnc1)P(=O)(O)O] | Ni(OAc)₂ 1.0 g | 0 | mL | 6 | mL | Not measured | 4.91 | 254 | mg | D |
| 23 | 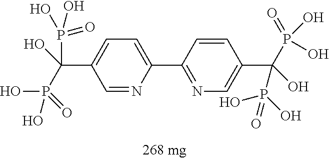 [SMILES: O=P(O)(O)C(O)(c1ccc(-c2ccc(C(O)(P(=O)(O)O)P(=O)(O)O)cn2)nc1)P(=O)(O)O] | Cu(OAc)₂ 800 mg | 1 | mL | 25 | mL | Not measured | 4.93 | 314 | mg | A |
| 24 | 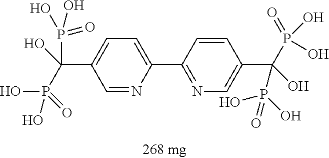 [SMILES: O=P(O)(O)C(O)(c1ccc(-c2ccc(C(O)(P(=O)(O)O)P(=O)(O)O)cn2)nc1)P(=O)(O)O] | Cu(OAc)₂ 800 mg | 1 | mL | 25 | mL | Not measured | 4.58 | 310 | mg | B |
| 25 | 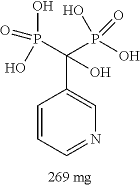 [SMILES: O=P(O)(O)C(O)(c1cccnc1)P(=O)(O)O] | 1. Cu(OAc)₂ 800 mg 2. Ba(OH)₂•8H₂O 315 mg | | | 25 | mL | Not measured | 5.05 | 330 | mg | B |
| 26 | 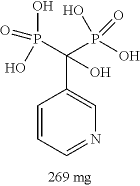 [SMILES: O=P(O)(O)C(O)(c1cccnc1)P(=O)(O)O] | 1. Cu(OAc)₂ 800 mg 2. Ca(OH)₂ 74 mg | 0 | mL | 25 | mL | Not measured | 4.95 | Unsuccessful, Cu separates out | | B |
| 27 | 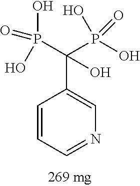 [SMILES: O=P(O)(O)C(O)(c1cccnc1)P(=O)(O)O] | 1. Cu(OAc)₂ 800 mg 2. Ca(OH)₂ 15 mg | 0 | mL | 25 | mL | Not measured | 4.55 | 420 | mg | B |
| 28 | 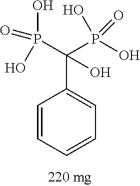 [SMILES: O=P(O)(O)C(O)(c1ccccc1)P(=O)(O)O] | Cu(OAc)₂ 653 mg | 0 | mL | 25 | mL | Not measured | 4.55 | 241 | mg | B |
| 29 | 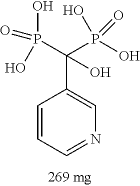 [SMILES: O=P(O)(O)C(O)(c1cccnc1)P(=O)(O)O] | 1. Cu(OAc)₂ 800 mg 2. Ca(OH)₂ 35 mg | 0 | mL | 25 | mL | Not measured | Not measured | Unsuccessful, Cu separates out | | B |
| 30 | 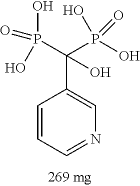 [SMILES: O=P(O)(O)C(O)(c1cccnc1)P(=O)(O)O] | 1. Cu(OAc)₂ 796 mg 2. Mg(OH)₂ 32 mg | 0 | mL | 25 | mL | Not measured | 4.99 | 275 | mg | B |
| 31 | 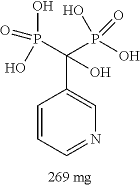 [SMILES: O=P(O)(O)C(O)(c1cccnc1)P(=O)(O)O] | 1. Cu(OAc)₂ 800 mg 2. Ba(OH)₂•8H₂O 78 mg | 0 | mL | 25 | mL | Not measured | 4.62 | 365 | mg | B |
| 32 | 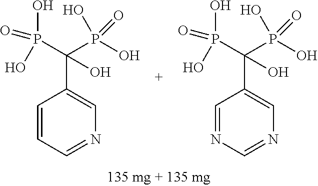 [SMILES: O=P(O)(O)C(O)(c1cccnc1)P(=O)(O)O ; O=P(O)(O)C(O)(c1cncnc1)P(=O)(O)O] | Cu(OAc)₂ 796 mg | 0 | mL | 25 | mL | Not measured | 4.73 | 285 | mg | B |
| 33 | 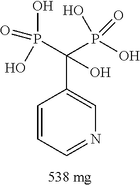 [SMILES: O=P(O)(O)C(O)(c1cccnc1)P(=O)(O)O] | Cu(OAc)₂ 1.6 g | 0 | mL | 50 | mL | Not measured | 4.45 | 694 | mg | B |
| 34 | 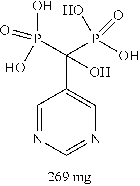 [SMILES: O=P(O)(O)C(O)(c1cncnc1)P(=O)(O)O] | Cu(OAc)₂ 796 mg | 0 | mL | 25 | mL | Not measured | 4.33 | 405 | mg | B |
| 35 | 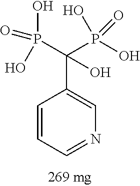 [SMILES: O=P(O)(O)C(O)(c1cccnc1)P(=O)(O)O] | Cu(OAc)₂ 796 mg | 1 | mL | 2 | mL | 4.42 | 4.43 | 365 | mg | C |
| 36 | 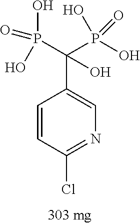 [SMILES: O=P(O)(O)C(O)(c1ccc(Cl)nc1)P(=O)(O)O] | Cu(OAc)₂ 796 mg | 0 | mL | 25 | mL | Not measured | 4.45 | 343 | mg | C |
| 37 | 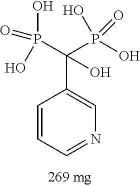 [SMILES: O=P(O)(O)C(O)(c1cccnc1)P(=O)(O)O] | Cu(OAc)₂ 796 mg | 2 | mL | 25 | mL | 6.18 | 4.53 | 369 | mg | C |
| 38 | 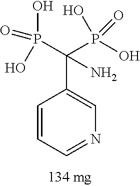 [SMILES: NC(c1cccnc1)(P(=O)(O)O)P(=O)(O)O] | Cu(OAc)₂ 398 mg | 0 | mL | 15 | mL | Not measured | 4.56 | 95 | mg | B |
| 39 | 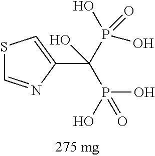 [SMILES: O=P(O)(O)C(O)(c1cscn1)P(=O)(O)O] | Cu(OAc)₂ 796 mg | 0 | mL | 25 | mL | 2.15 | 4.30 | 250 | mg | B |
| 40 | 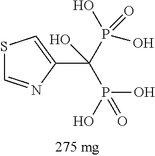 [SMILES: O=P(O)(O)C(O)(c1cscn1)P(=O)(O)O] | Cu(OAc)₂ 796 mg | 1 | mL | 25 mL | | 2.93 | 4.62 | 273 | mg | C |
| 41 | 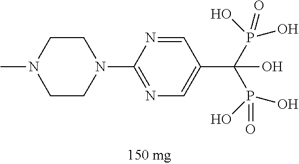 [SMILES: CN1CCN(c2ncc(C(O)(P(=O)(O)O)P(=O)(O)O)cn2)CC1] | Cu(OAc)₂ 326 mg | 0 | mL | 12.5 | mL | 2.89 | 4.68 | 110 | mg | B |
| 42 | 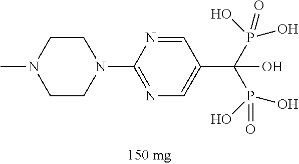 [SMILES: CN1CCN(c2ncc(C(O)(P(=O)(O)O)P(=O)(O)O)cn2)CC1] | Cu(OAc)₂ 796 mg | 1 | mL | 12.5 | mL | 2.93/6.71 | 5.16 | 273 | mg | C |
| 43 | 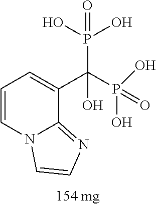 [SMILES: O=P(O)(O)C(O)(c1cccn2ccnc12)P(=O)(O)O] | Cu(OAc)₂ 398 mg | 0.5 | mL | 15 | mL | 6.66 | 4.31 | 145 | mg | C |
| 44 | 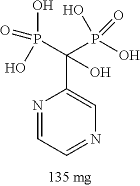 [SMILES: O=P(O)(O)C(O)(c1cnccn1)P(=O)(O)O] | Cu(OAc)₂ 398 mg | 0.5 | mL | 15 | mL | 2.88 | 4.46 | 180 | mg | C |
| 45 | 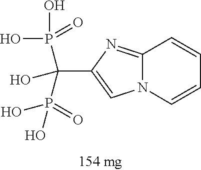 [SMILES: O=P(O)(O)C(O)(c1cn2ccccc2n1)P(=O)(O)O] | Cu(OAc)₂ 398 mg | 0.5 | mL | 15 | mL | 6.23 | 4.75 | 173 | mg | C |
| 46 | 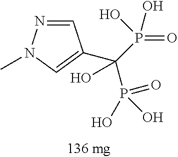 [SMILES: Cn1cc(C(O)(P(=O)(O)O)P(=O)(O)O)cn1] | Cu(OAc)₂ 398 mg | 0.5 | mL | 15 | mL | 3.11 | 4.72 | 183 | mg | C |
| 47 | 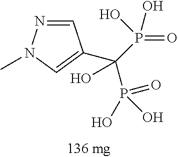 [SMILES: Cn1cc(C(O)(P(=O)(O)O)P(=O)(O)O)cn1] | Cu(OAc)₂ 398 mg | 0.5 | mL | 15 | mL | 5.56 | 4.64 | 134 | mg | C |
| 48 | 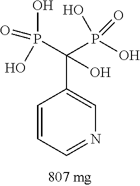 [SMILES: O=P(O)(O)C(O)(c1cccnc1)P(=O)(O)O] | Cu(OAc)₂ 2.38 g | 3 | mL | 75 | mL | 5.15 | 4.73 | 1.153 | g | C |
| 49 | 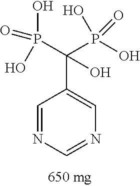 [SMILES: O=P(O)(O)C(O)(c1cncnc1)P(=O)(O)O] | Cu(OAc)₂ 1.92 g | 2.4 | mL | 60 | mL | 5.24 | 4.88 | 938 | mg | C |

The foregoing examples show that the novel metal organic frameworks in accordance with the present invention can be obtained using various processes.

### Examples 50-69

### Electrochemical Reduction of Carbon Dioxide

The catalytic activity of the MOF in the process in accordance with the present invention was qualitatively determined by cyclovoltammetry.

The cyclovoltammetric measurements were taken by applying an electrical potential from E=0V to the negative values of about E=−1.2V. Subsequently, the potential was increased gradually to the positive values to about V=+1.2V. Subsequently, the potential was returned to E=0V thus closing the cycle. Cyclovoltammetric curves show the dependence between electrical potential and E and the current I. When a reaction occurs at a given potential E, the current I flows and is recorded as a signal. The larger signal I, the faster is the reaction. The signals at E<0V indicate reduction, while those at E>0V are the signals of oxidation processes.

The catalytic activity of the MOF for the electrochemical reduction of carbon dioxide is indicated by a difference in the V-I profiles of the reduction curve under carbon dioxide compared to the respective characteristics under nitrogen. Three characteristic signals in the range of from −0.16 to −0.6 V were indicative or reduction processes in which carbon dioxide was involved and the said three signals were evaluated by determining the electrical current flowing at these potentials. The larger the current, the faster the respective reduction reaction. The measurements were taken in 1M NaHCO₃ solution at a scan rate of 0.1 V/s.

Table 2 provides the electrochemical properties of MOF comprising bisphosphonic acids. The MOF of examples 50 to 65 were prepared by microwave synthesis. This involved mixing of the ingredients at room temperature in water and subjecting the mixture to a microwave radiation at 150° C. for one hour. In some samples the pH was adjusted with 1N sodium hydroxide prior to the microwave reaction. In Examples 66 to 69 the MOF was prepared by gradually adding a solution of the metal salt to an aqueous solution of the bisphosphonic acid at gentle reflux, followed by the addition of 1N sodium hydroxide. When the reactions were completed, the mixtures were filtered, washed thoroughly with water and methanol and dried first on the filter and then at 60° C. under vacuum overnight.

TABLE 2
Electrochemical properties of novel MOF (potentials referred to SCE)

| Materials | | | | Cyclic voltammetry | | | | | | | |
|---|---|---|---|---|---|---|---|---|---|---|---|
| | | Metal | | First peak | | Second peak | | Third peak | | | |
| | | Salt of | Initial ratio | | Iₚ,ₘₐₓ | | I_{p,max} | | I_{p,max} | Conditions | |
| Ex. | Acid. | Cu²⁺ | Metal/Acid | E | 10⁻⁸ | E | 10⁻⁸ | E | 10⁻⁸ | Additive | pH |
| 50 | 1 | (NO₃)₂ | 2 | −0.22 | 8.3 | −0.31 | 12.9 | −0.54 | 2.5 | 1 | nd |
| 51 | 1 | (NO₃)₂ | 3 | — | | −0.30 | 21.8 | −0.51 | 15.2 | 1 | nd |
| 52 | 1 | (AcO)₂ | 2 | −0.15 | 2.0 | −0.29 | 2.4 | −0.45 | | 1 | nd |
| 53 | 1 | (AcO)₂ | 3 | −0.21 | 8.3 | −0.30 | 10.7 | −0.51 | 8.2 | 1 | nd |
| 54 | 1 | (NO₃)₂ | 3 | Nd | | nd | | nd | | 2 | nd |
| 55 | 1 | (AcO)₂ | 3 | −0.17 | 2.5 | −0.29 | 3.6 | — | | 2 | nd |
| 56 | 1 | (NO₃)₂ | 4 | Nd | | nd | | nd | | 2 | nd |
| 57 | 1 | (AcO)₂ | 4 | — | | −0.31 | 33.1 | −0.58 | 18.7 | 2 | nd |
| 58 | 1 | (NO₃)₂ | 3 | −0.16 | 2.6 | — | | −0.44 | 4.6 | 3 | nd |
| 59 | 1 | (AcO)₂ | 3 | −0.22 | 7.7 | −0.31 | 6.8 | −0.51 | 9.7 | 3 | nd |
| 60 | 1 | (NO₃)₂ | 2 | −0.18 | 6.5 | −0.38 | 4.4 | −0.50 | 5.4 | 3 | nd |
| 61 | 1 | (AcO)₂ | 4 | — | | −0.33 | 42.1 | −0.58 | 21.7 | 3 | nd |
| 62 | 2 | (AcO)₂ | 4 | −0.24 | 15.8 | −0.31 | 30.5 | −0.50 | 20.6 | — | 5.03 |
| 63 | 2 | (AcO)₂ | 4 | −0.15 | 4.5 | −0.25 | 9.5 | −0.45 | 6.7 | 3 | 5.05 |
| 64 | 3 | (AcO)₂ | 4 | −0.21 | 8.1 | −0.33 | 15.1 | −0.56 | 13.2 | — | 5.03 |
| 65 | 2 | (NO₃)₂ | 4 | −0.24 | 9.4 | −0.33 | 19.6 | −0.58 | 14.2 | — | 5.00 |
| 66 | 2 | (NO₃)₂ | 4 | −0.19 | 5.9 | −0.41 | 8.6 | −0.58 | 7.0 | — | nd |
| 67 | 1 | (AcO)₂ | 4 | −0.23 | 11.5 | −0.35 | 13.5 | −0.53 | 7.0 | — | |
| 68 | 1 | (OH)₂ | 4 | Nd | | nd | | nd | | — | 6.81 |
| 69 | 1 | (AcO)₂ | 4 | −0.22 | 10.0 | −0.31 | 17.5 | −0.58 | 10.0 | | |

Legend for Table 2:
Acids 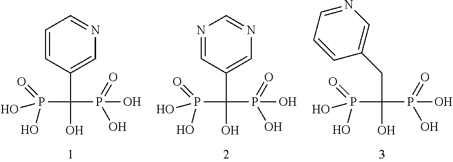 [SMILES: O=P(O)(O)C(O)(c1cccnc1)P(=O)(O)O ; O=P(O)(O)C(O)(c1cncnc1)P(=O)(O)O ; O=P(O)(O)C(O)(Cc1cccnc1)P(=O)(O)O]
Additives

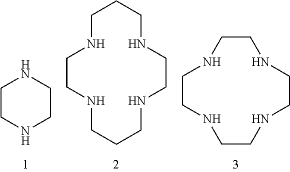

The results in Table 2 show the catalytic activity of the respective MOF in reduction reactions involving carbon dioxide. In the experiments, the presence of an additive or the nature of the additive did not influence the catalytic activity to a significant extent. The nature of the metal salt in the experiments has a certain influence on the activity and there is also a tendency towards an increase in activity if the ratio of metal salt to bisphosphonic acid is increased.

In the examples, copper as a metal yielded the best results.

### Examples 70 to 83

### Quantitative Measurements of Products

To investigate the outcome of the reduction of carbon dioxide, electrodes comprising a stainless steel wire disk serving as a conductive scaffold on which about 1:1 (wt/wt) mixture of metal organic framework and graphite plus about 0.25 wt parts of PTFE as a binder was pressed. The cell was a cell comprising two flasks connected by an ion-conductive frit. The quantitative measurements were carried out in non-aqueous solvents, namely dimethyl formamide and acetonitrile. In principle, the reaction could also be carried out in aqueous media, but in some experiments conducted in aqueous systems, there were no satisfactory results obtained. Electrochemical reduction was carried out in non-aqueous solvents at an electrode potential of −2V and a cell voltage of 11.8 V. To analyze the reaction products, gas chromatography columns were used capable of resolving a wide range of products potentially formed in electrocatalytic reduction of carbon dioxide. The resolution capabilities were confirmed by running well defined mixtures of gaseous and soluble controls made of substances which could be formed in this reaction. Detection of products was made by electron ionization mass spectrometry.

Table 3 shows the result of the reduction carried out in dimethyl formamide as solvent whereas Table 4 shows the respective results obtained in acetonitrile as a solvent, which in the experiments showed to be the most effective solvent.

TABLE 3
DMF as a solvent

| | | Cyclovoltametry | CO formed in 2 hrs |
|---|---|---|---|
| Ex | Electrode Material | result (*) | [%] |
| 70 | metal disk | N | 3.9 |
| 71 | graphite | N | 4.9 |
| 72 | 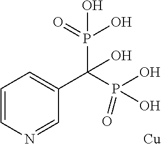 | A | 7.9 |

TABLE 4
Acetonitrile as solvent

| | | Cyclovoltametry | CO formed in 2 hrs |
|---|---|---|---|
| Ex | Electrode Material | result (*) | [%] |
| 73 | graphite | N | 11.2 |
| 74 | graphite | N | 12.7 |
| 76 | graphite | N | 9.1 |
| 75 76 | 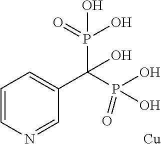 | A A | 16.0 15.5 |
| 77 | Basolite ®-300 Cu¹⁾ | A | 15.3 |
| 78 | 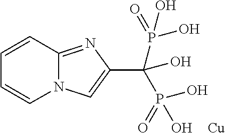 | nt | 15.0 |
| 79 | 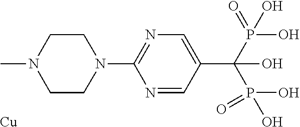 | nt | 12.4 |
| 80 | 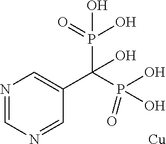 | A | 8.6 |
| 81 | 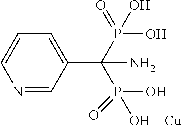 | nt | 17.5 |
| 82 | 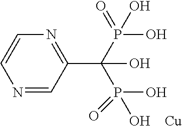 | nt | 0 |
| 83 | 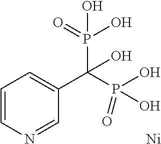 | N | 10.2 |

*A = active, N = not active, nt = not tested
¹⁾Metal organic framework commercially available from BASF SE, based on benzene-1,3,5-tricarboxylic acid and copper as metal ion

The results show that MOF in general and in particular novel MOF in accordance with the present invention provide a selective conversion of carbon dioxide to carbon monoxide.

Should the disclosure of any patents, patent applications, and publications which are incorporated herein by reference conflict with the description of the present application to the extent that it may render a term unclear, the present description shall take precedence.

1. A process for the catalyzed electrochemical reduction of carbon dioxide wherein the process comprises using, as a catalyst, a metal organic framework comprising at least one metal ion and at least one organic ligand.

2. The process in accordance with claim 1, wherein the metal ions are selected from metals of groups 2 to 15 of the periodic system.

3. The process in accordance with claim 2, wherein the metal ion is based on copper.

4. The process in accordance with claim 1, wherein an organic ligand or ligand mixture is used having at least one of an alkyl group substructure, having from 1 to 10 carbon atoms or of an aryl group substructure having from 1 to 5 aryl or heteroaryl rings comprising from 5 to 20 ring atoms, the ligand substructure having bound thereto at least one functional group, wherein the at least one functional group is selected from COOH, CS₂H, NO₂, SO₃H, Si(OH)₃, Ge(OH)₃, Sn(OH)₃, Si(SH)₄, Ge(SH)₄, PO₃H, PO₃H₂, AsO₃H, AsO₄H, P(SH)₃, As(SH)₃, CH(SH)₂, C(SH)₃, CH(NH₂)₂, C(NH₂)₃, CH(OH)₂, C(OH)₃, CH(CN)₂, C(CN)₃, CH(RSH)₂, CRSH)₃, CH(RNH₂)₂, C(RNH₂)₃, CH(ROH)₂, C(ROH)₃, CH(RCN)₂, and C(RCN)₃, wherein R is an alkyl group having from 1 to 5 carbon atoms or an aryl group having from 1 to 2 phenyl rings, CH(SH)₂, C(SH)₃, CH(NH₂)₂, C(NH₂)₃, CH(OH)₂, C(OH)₃, CH(CN)₂ and C(CN)₃.

5. (canceled)

6. The process in accordance with claim 1, wherein carbon dioxide is reduced to carbon monoxide rich products.

7. A metal organic framework, comprising at least one metal ion and at least one alpha-substituted bisphosphonic acids as organic ligand.

8. The metal organic framework in accordance with claim 7, wherein the bisphosphonic acid is represented by the general structure 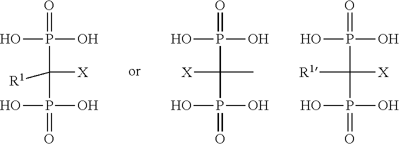
wherein R¹ is selected from the group consisting of C₂-C₁₈ alkyl, C₂-C₁₈-alkenyl or C₂-C₁₈-alkynyl groups, which may be substituted or unsubstituted and in which one or more carbon atoms may be replaced by a heteroatom selected from O, N and S, 5 to 20-membered cycloalkyl or aryl or 5- to 20-membered heteroaryl comprising at least one heteroatom selected from S, O or N, wherein the ring systems may be substituted or unsubstituted or may be annealed with one or more other ring systems, C₁-C₈-alkylaryl or C₁-C₈ heteroaryl alkyl and X is selected from hydrogen, halogen OR², NR³R⁴, SR⁵, CR⁶R⁷R⁸ where R² to R⁵ independently of each other may be hydrogen, C₁-C₁₈ alkyl, C₁-C₈ arylalkyl or C₁-C₈ heteroarylalkyl, 5 to 20-membered membered cycloalkyl or aryl or 5- or 6-membered heteroaryl rings comprising at least one heteroatom selected from S, O or N and R⁶ to R⁸, independently of each other, may have the meanings as defined for R¹ above or may be a carbonyl group or X may be CN and R¹′ is a divalent residue derived from R¹ bridging two bisphosphonic acid groups.

9. The metal organic framework in accordance with claim 8, wherein X is H, F, OH, NH₂ or CN.

10. The metal organic framework in accordance with claim 7, wherein the ligand comprises at least one aryl or heteroaryl ring having of from 5 to 20 ring atoms.

11. The metal-organic framework in accordance with claim 9, wherein the heteroaryl ring is selected from 5- or 6-membered heteroaryl rings comprising at least one heteroatom selected from S, O or N.

12. The metal organic framework in accordance with claim 11, wherein the bisphosphonic acid is selected from the group consisting of

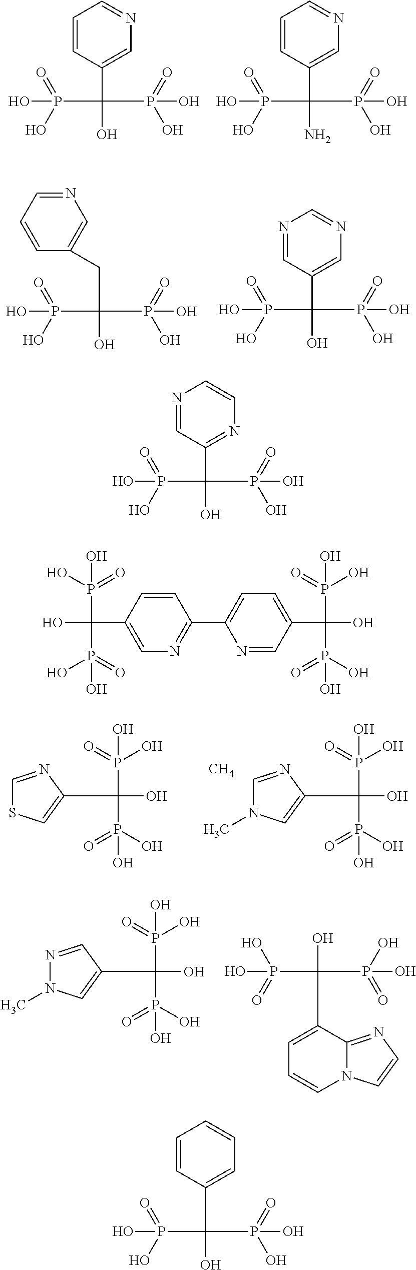

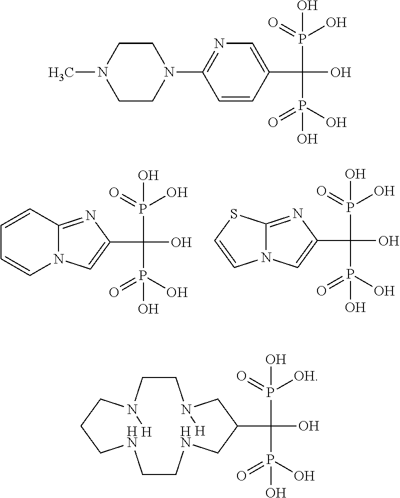

13. The metal organic framework in accordance with claim 12, wherein the bisphosphonic acid is selected from the group consisting of

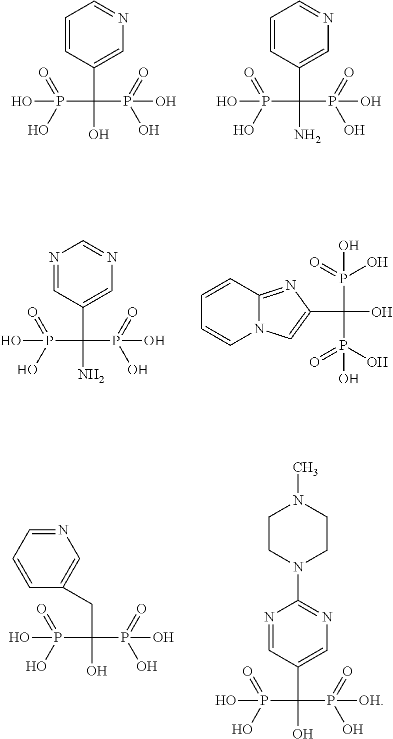 [SMILES: O=P(O)(O)C(O)(c1cccnc1)P(=O)(O)O ; NC(c1cccnc1)(P(=O)(O)O)P(=O)(O)O ; NC(c1cncnc1)(P(=O)(O)O)P(=O)(O)O ; O=P(O)(O)C(O)(c1cn2ccccc2n1)P(=O)(O)O ; O=P(O)(O)C(O)(Cc1cccnc1)P(=O)(O)O ; CN1CCN(c2ncc(C(O)(P(=O)(O)O)P(=O)(O)O)cn2)CC1]

14. (canceled)

15. A method for electrochemically reducing carbon dioxide, the method comprising using the metal organic framework in accordance with claim 7 as a catalyst.

16. The method in accordance with claim 15, wherein the bisphosphonic acid is represented by the general structure 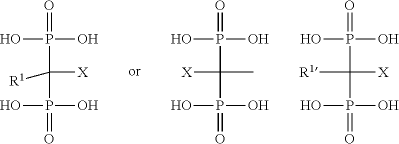
wherein R¹ is selected from the group consisting of C₂-C₁₈ alkyl, C₂-C₁₈-alkenyl or C₂-C₁₈-alkynyl groups, which may be substituted or unsubstituted and in which one or more carbon atoms may be replaced by a heteroatom selected from O, N and S, 5 to 20-membered cycloalkyl or aryl or 5- to 20-membered heteroaryl comprising at least one heteroatom selected from S, O or N, wherein the ring systems may be substituted or unsubstituted or may be annealed with one or more other ring systems, C₁-C₈-alkylaryl or C₁-C₈ heteroaryl alkyl and X is selected from hydrogen, halogen OR², NR³R⁴, SR⁵, CR⁶R⁷R⁸ where R² to R⁵ independently of each other may be hydrogen, C₁-C₁₈ alkyl, C₁-C₈ arylalkyl or C₁-C₈ heteroarylalkyl, 5 to 20-membered membered cycloalkyl or aryl or 5- or 6-membered heteroaryl rings comprising at least one heteroatom selected from S, O or N and R⁶ to R⁸, independently of each other, may have the meanings as defined for R¹ above or may be a carbonyl group or X may be CN and R¹′ is a divalent residue derived from R¹ bridging two bisphosphonic acid groups.

17. The method in accordance with claim 16, wherein X is H, F, OH, NH₂ or CN.

18. The method in accordance with claim 15, wherein the ligand comprises at least one aryl or heteroaryl ring having of from 5 to 20 ring atoms.

19. The method in accordance with claim 16, wherein the heteroaryl ring is selected from 5- or 6-membered heteroaryl rings comprising at least one heteroatom selected from S, O or N.

20. The method in accordance with claim 19, wherein the bisphosphonic acid is selected from the group consisting of

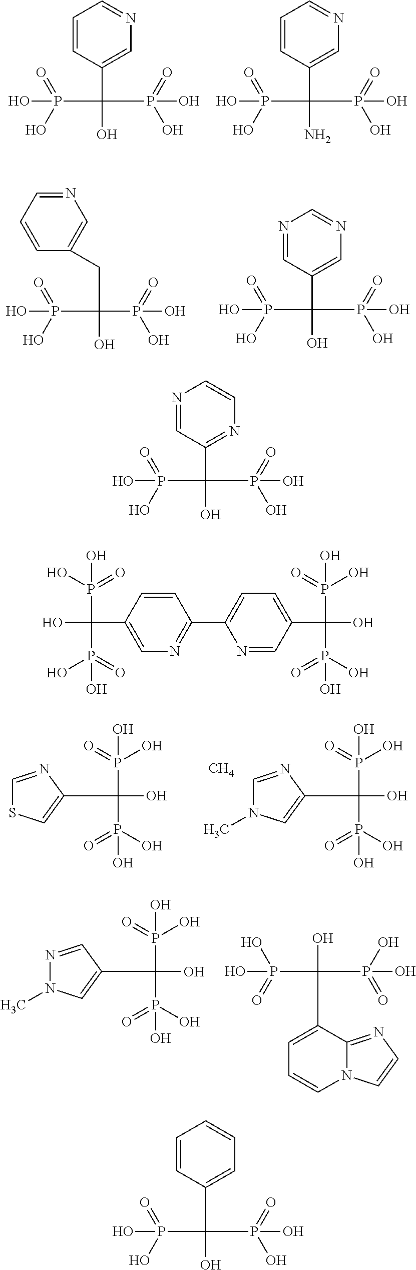

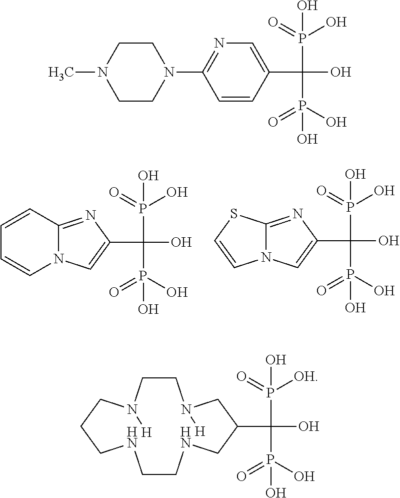

21. The method in accordance with claim 20, wherein the bisphosphonic acid is selected from the group consisting of 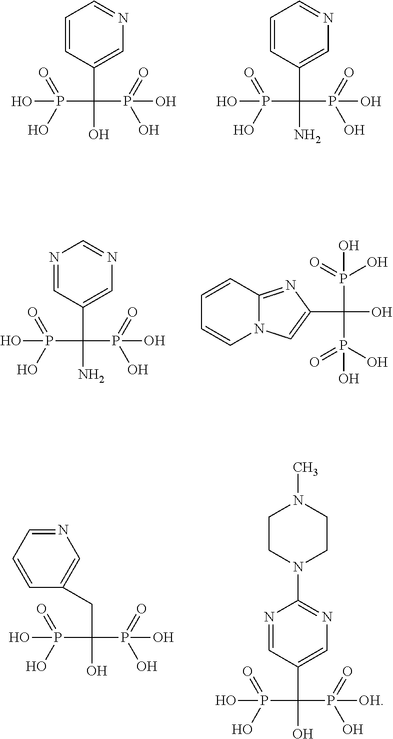 [SMILES: O=P(O)(O)C(O)(c1cccnc1)P(=O)(O)O ; NC(c1cccnc1)(P(=O)(O)O)P(=O)(O)O ; NC(c1cncnc1)(P(=O)(O)O)P(=O)(O)O ; O=P(O)(O)C(O)(c1cn2ccccc2n1)P(=O)(O)O ; O=P(O)(O)C(O)(Cc1cccnc1)P(=O)(O)O ; CN1CCN(c2ncc(C(O)(P(=O)(O)O)P(=O)(O)O)cn2)CC1]
